(19) United States
(12) Patent Application Publication
(10) Pub. No.: US 2014/0161342 A1
(43) Pub. Date: Jun. 12, 2014

(54) DENSITY-BASED METHOD OF COMPARING IMAGES AND DETECTION OF MORPHOLOGICAL CHANGES USING THE METHOD THEREOF

(71) Applicants: Kristine Schauer, Paris (FR); Thanh Buu Duong, Paris (FR); Bruno Goud, Paris (FR)

(72) Inventors: Kristine Schauer, Paris (FR); Thanh Buu Duong, Paris (FR); Bruno Goud, Paris (FR)

(73) Assignee: CENTRE NATIONAL DE LA RECHERCHE SCIENTIFIQUE CNRS, Paris Cedix 16 (FR)

(21) Appl. No.: 14/233,433

(22) PCT Filed: Jul. 19, 2012
(86) PCT No.: PCT/EP2012/064239

§ 371 Date: Jan. 17, 2014

(30) Foreign Application Priority Data
Jul. 20, 2011 (EP) 13305946.3

(51) Int. Cl. G06K 9/00

(52) U.S. Cl. CPC G06K 9/00147
USPC 382/133

(57) ABSTRACT

A method of processing data for comparing at least two images using data processing elements, includes extracting a first sample of coordinate values (X₁, . . . , Xₙ₁) from at least one first image (Im1) and a second sample of coordinate values (Y₁, . . . , Yₙ₂) from at least one second image (Im2). A normal score value (Z) is then computed, with the processing elements, based on a density test statistic function (\hat{T}) applied on the first and second samples of coordinate values, wherein this density test statistic function has an asymptotic distribution, and a p-value, derived from the computed normal score value (Z), is compared (400) with a predetermined level of significance (α) in order to determine a similarity between the two images. The method can be used for determining the influence and assessing the cytotoxicity of a compound, monitoring a drug treatment, determining cellular morphology changes and the influence of an infection by pathogens.

### FIELD OF THE INVENTION

The present invention relates to the field of image processing, and more specifically to the comparison of images acquired from biological structures in order to study morphological changes or compound influence on such biological structures.

### BACKGROUND OF THE INVENTION

In many technical fields, the problem of comparing data samples has attracted much research to investigate its theoretical and practical aspects.

Historically, the first comparison methods involved small computational burdens. For instance, the so-called “t-test” relied on fitting normal distributions having equal variance values but different mean values, thus reducing the original problem of data comparison to a comparison for a difference between the mean values.

However, such a t-test test is limited, because if the marginal variance values are not equal, even approximately, it can give erroneous statistical significance results.

On the other hand, while more sophisticated parametric tests have also been introduced, such parametric tests do not overcome the basic problem of pre-specifying the parametric form.

There exist also non-parametric tests, such as the Mann-Whitney, Kolmogorov-Smirnov and Wald-Wolfowitz tests. The first of these tests is based on the ranks from the combined samples, the second on the supremum distance between two distribution functions, and the third on the consecutive runs of membership from the two samples. However, such univariate tests apply only for 1-dimensional continuous data and cannot apply to multivariate data.

When it comes to tests for multivariate data, one approach is based on data depth as a multivariate analogue of ranking, but such approach has not met the same wide acceptance as the above-mentioned univariate tests, because the former have not consistently yielded intuitive inferences when applied to experimental data.

Testing multivariate date can be achieved by computationally intensive resampling methods, however a second major trade-off is that they require sufficient familiarity as resampling requires calibration for each data analysis situation at hand.

In the field of comparing cellular endomembrane organization, a resampling strategy has been described in “Probabilistic density maps to study global endomembrane organization”, Schauer, Duong et al., NATURE METHODS, 30 May 2010, wherein a statistical analysis using non-parametric Kernel density estimators is used.

Such a technique has proven to be a more flexible procedure, at the cost of an increased computational burden due to the calculation of the critical quantiles of the null distribution via resampling, which requires calibration for each data analysis situation at hand. Such constraints prevent the wider use of bootstrap density-based two-sample tests outside the computational statistical community. In particular, these tests are not easily available to biologists.

### SUMMARY OF THE INVENTION

It is thus an object of the present invention to overcome the above-identified difficulties and disadvantages by providing a multivariate data samples comparison method, which does not unduly increase the computational burden and remains accessible to non-experts of the computational statistical community. The invention also relates to the practical applications of such a method, in particular in the biological field.

The invention thus relates to a method of processing data for comparing at least two images using data processing means, the method comprising:

extracting a first sample of coordinate values from at least one first image and a second sample of coordinate values from at least one second image;

computing, with said processing means, an approximate normal score value based on a density test statistic function applied on the first and second samples of coordinate values, wherein said density test statistic function has an asymptotic distribution which can be normal or not;

comparing a p-value, derived from the computed normal score value, with a predetermined level of significance in order to determine a similarity between the two images.

Advantageously, the density test statistic function is a kernel density test statistic function.

Advantageously, said density test statistic function is a multivariate kernel density test statistic function.

In one preferred embodiment, the normal score value depends on the mean value of the density test statistic function. This normal score value can further depend both on the mean value and the variance value of the density test statistic function.

Thus, in its embodiment, the method according to the present invention further comprises the following steps:

selecting a first and a second optimal bandwidth matrices which are associated respectively with the first and second samples of coordinate values, wherein said bandwidth matrices are preferably a sequence of symmetric positive definite matrices; and

determining the mean value estimator, and eventually the variance estimator, of the density test statistic function based on the selected optimal bandwidth matrices;

wherein the density test statistic function is preferably based on a first estimator of a first integrated density functional associated with the first sample of coordinate values and a second estimator (of a second integrated density functional associated with the second sample coordinate values; and

wherein said first and second bandwidth matrices are preferably selected to minimize the mean square error respectively of the first and second estimators in the space of all symmetric positive definite matrices.

The invention further relates to a computer program product comprising code instructions for implementing the steps of a method of processing data according to the invention, when loaded and run on data processing means of an analyzing device.

The invention also relates to a method for detecting a change between a first biological structure and a second biological structure, the method comprising the step of comparing an image of the first biological structure to an image of the second biological structure using the method according to the invention, wherein a change is detected when the image of the first biological structure and the image of the second biological structure are not found similar by said method according to the invention.

The invention still relates to an analyzing device for detecting a change in a biological structure, the analyzing device comprising:

image acquiring means able to capture at least one first image of a first element of said biological structure and at least one second image of a second element of this biological structure; and

processing means configured to extract a first sample of coordinate values from the first image and a second sample of coordinate values from the second image, compute a normal score value based on a density test statistic function applied on the first and second samples of coordinate values, wherein the density test statistic function has an asymptotic distribution, and compare a p-value, derived from the computed normal score value, with a predetermined level of significance in order to determine a similarity between the first and second images.

Further embodiments of the method of processing data, the computer program product, the method for detecting a change and the analyzing device according to the present invention are described in the dependent claims.

### BRIEF DESCRIPTION OF THE DRAWINGS

Other features and advantages of the invention will become apparent from the following description of non-limiting exemplary embodiments, with reference to the appended drawings, in which:

FIG. 1 is a flow chart of a method of processing data for comparing images according to the present invention;

FIG. 2 is a detailed flow chart of an embodiment of the normal score value computation step of method of processing data for comparing two images according to the present invention;

FIG. 3A shows a flowchart illustrating a general method of determining whether a cellular condition is similar or not to another cellular condition, using the method of processing data for comparing images according to the present invention;

FIG. 3B shows a flowchart of a method of determining the influence of a compound on a biological structure, which uses the method of determining whether a cellular condition is similar or not to another cellular condition according to the present invention;

FIG. 3C illustrates a comparison of p-values obtained with the present invention and with the prior art method based on a resampling technique.

FIG. 4 shows a flowchart of a method for detecting morphological changes over time of a biological structure, which uses the method of processing data for comparing images according to the present invention; and

FIGS. 5-17 illustrate examples of detection of morphological changes in eukaryotic cells using the methods of processing data for comparing images and determining the influence of a compound on a biological structure according to the present invention

### DETAILED DESCRIPTION OF THE INVENTION

Next some embodiments of the present invention are described in more details with reference to the attached figures.

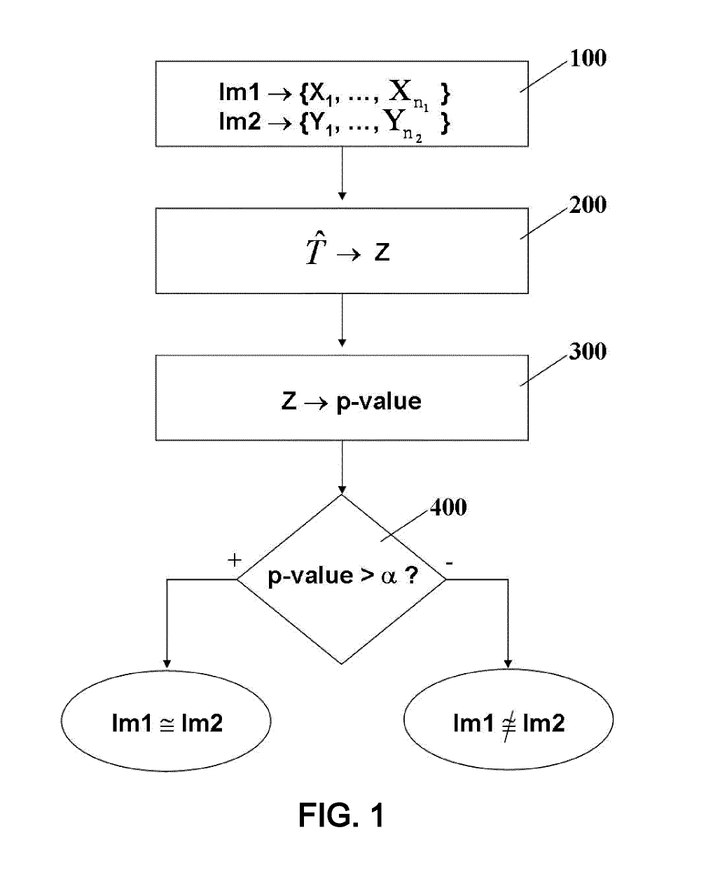

FIG. 1 shows a flow chart of a method of processing data for comparing two images according to the present invention.

Such a method of processing data is being carried out with data processing means such as, for instance, a computer or a microprocessor, which are provided with at least two images Im₁, Im₂ in a suitable format.

This method comprises a first step 100 of extracting a first sample of coordinate values X₁, . . . , Xₙ_{₁} (wherein n₁ is the number of coordinate values in this first sample) from at least one first image Im1, as well as a second sample of coordinate values Y₁, . . . , Yₙ_{₂} (wherein n₂ is the number of coordinate values in this second sample) from at least one second image Im2. For the sake of explaining the invention, the comparison of only two images Im1, Im2 is hereunder described. However, this method can naturally apply to the comparison of any higher number of images, by extrapolation.

This step 100 can be carried out, for instance, by capturing images Im1 and Im2 using image acquiring means such as a microscope, then selecting specific points from these images (selecting n₁ in the first image Im1 and selecting n₂ in the second image Im2), using a segmentation technique and markers such as fluorescent markers able to reveal these specific points, and memorizing the coordinate values of each of these selected points.

These coordinate values can be two-dimensional coordinate values or three-dimensional coordinate values, depending on the type of image acquiring means used for capturing the images. For instance, when fluorescent markers attached to proteins or intracellular structures of interest are used in conjunction with three-dimensional fluorescent microscopy, sample of three-dimensional coordinate values can be extracted.

In some specific situations, it may be advantageous to compare a first group of n1 images {Im1(i)}_{1≦i≦n} with a second group of n2 images {Im2(i)}_{1≦i≦n′}, for instance in order to average, in time or in population, the comparison of images representing two subjects to be compared.

In such a situation, the first sample of coordinate values X₁, . . . , Xₙ_{₁} may be obtained from the plurality of images Im1(1), . . . , Im1(n1) of the first group, and the second sample of coordinate values Y₁, . . . , Yₙ_{₂} may be obtained from the plurality of second images Im2(1), . . . , Im2(n2) of the second group.

This can be achieved, for instance, by superimposing the plurality of images Im1(1), . . . , Im1(n1) in order to form a single first image Im1, and then extracting n1 coordinate values X₁, . . . , Xₙ_{₁} from this single first image Im1. A similar operation is then performed with the plurality of images Im2(1), . . . , Im2(n2) of the second group. Alternatively, the samples of coordinate values may be extracted sequentially from the individual images Im1(1), . . . , Im1(n1) and Im2(1), . . . , Im2(n2).

Once the two samples of coordinate values X₁, . . . , Xₙ_{₁} and Y₁, . . . , Yₙ_{₂} have been provided to the processing means, these processing means compute (step 200) a normal score value Z based on a density test statistic function \hat{T} applied on these first sample and second sample of coordinate values.

Here, in order to avoid using bootstrap resampling and thus to provide a solution which does not require frequent changes of parameters as it is the case in a permutation method using such a bootstrap resampling, the density test statistic function \hat{T} is being chosen to present an asymptotic distribution.

Such a density test statistic function \hat{T} having an asymptotic distribution can be constructed as follows:

If one considers that the first sample of coordinate values {X₁, . . . , Xₙ_{₁}} and the second sample of coordinate values {Y₁, . . . , Yₙ_{₂}} are d-variate random samples having respective common density functions f₁ and f₂, the respective kernel density estimates of these density functions f₁ and f₂ are defined as follows:

$${\hat{f}}_{1} ( x ; {H}_{1} ) = {n}_{1}^{- 1} \cdot {\sum }_{i = 1}^{{n}_{1}} {K}_{{H}_{1}} ( x - {X}_{i} ) \qquad ( 1 )$$

$${\hat{f}}_{2} ( x ; {H}_{2} ) = {n}_{2}^{- 1} \cdot {\sum }_{i = 1}^{{n}_{2}} {H}_{{H}_{2}} ( x - {Y}_{i} ) \qquad ( 2 )$$

Where K is a kernel function according to the following equation:

$${K}_{{H}_{k}} ( x ) = {\vert {H}_{k} \vert}^{- \frac{1}{2}} \cdot K ( {( {H}_{k} )}^{- \frac{1}{2}} x ) , \qquad ( 3 )$$

wherein Hₖ is a bandwidth matrix for k=1 or 2.

Such a bandwidth matrix can be defined as a matrix of smoothing parameters, for controlling the amount of smoothing in the density test statistic function.

In order to compare the two samples of coordinate values, and thus the two images Im1 and Im2 represented by these samples, a null hypothesis Hyp₀ can be defined as Hyp₀: f₁≡f₂ (corresponding to the hypothesis that the two images Im1 and Im2 are similar) and this null hypothesis can be tested with a discrepancy measure between the two density functions f₁ and f₂.

In the present invention, such a test can be implemented with reference to a discrepancy T defined according to the following equation:

T=∫[f₁(x)−f₂(x)]²dx=ψ₁+ψ₂−(ψ_{1,2}+ψ_{2,1}) (4)

Wherein ψ₁, ψ₂, ψ_{1,2} and ψ_{2,1} are integrated density functionals defined as follows:

ψₖ=∫fₖ(x)²dx, for k=1,2 (5)

ψₖ_{_{1,k2}}=∫fₖ₁(x)·fₖ₂(x)dx, for(k1,k2)=(1,2)or(2,1) (6)

The density test statistic function \hat{T} corresponding to the above-mentioned discrepancy T can be obtained by substituting these integrated density functionals with their estimators in the above-mentioned equation, i.e.:

\hat{T}=\hat{ψ}₁+\hat{ψ}₂−(\hat{ψ}_{1,2}+\hat{ψ}_{2,1}) (7)

These estimators being defined as follows:

$$\begin{matrix}\begin{matrix}{\hat{ψ}}_{1} ≡ {\hat{ψ}}_{1} ( {H}_{1} ) \\ = {n}_{1}^{- 1} {\sum }_{i = 1}^{{n}_{1}} {\hat{f}}_{1} ( {X}_{i} ; {H}_{1} ) \\ = {n}_{1}^{- 2} {\sum }_{i 1 = 1}^{{n}_{1}} {\sum }_{i 2 = 1}^{{n}_{1}} {K}_{{H}_{1}} ( {X}_{i 1} - {X}_{i 2} )\end{matrix} & ( 8 ) \\ \begin{matrix}{\hat{ψ}}_{2} ≡ {\hat{ψ}}_{2} ( {H}_{2} ) \\ {n}_{2}^{- 1} {\sum }_{j = 1}^{{n}_{2}} {\hat{f}}_{2} ( {Y}_{j} ; {H}_{2} ) \\ {n}_{2}^{- 2} {\sum }_{j 1 = 1}^{{n}_{2}} {\sum }_{j 2 = 1}^{{n}_{2}} {K}_{{H}_{2}} ( {Y}_{j 1} - {Y}_{j 2} )\end{matrix} & ( 9 ) \\ \begin{matrix}{\hat{ψ}}_{1 , 2} ≡ {\hat{ψ}}_{1 , 2} ( {H}_{1} ) \\ = {n}_{2}^{- 1} {\sum }_{j = 1}^{{n}_{2}} {\hat{f}}_{1} ( {Y}_{j} ; {H}_{1} ) \\ = {n}_{1}^{- 1} \cdot {n}_{1}^{- 1} {\sum }_{i = 1}^{{n}_{1}} {\sum }_{j = 1}^{{n}_{2}} {K}_{{H}_{1}} ( {X}_{i} - {Y}_{j} )\end{matrix} & ( 10 ) \\ \begin{matrix}{\hat{ψ}}_{2 , 1} ≡ {\hat{ψ}}_{2 , 1} ( {H}_{2} ) \\ = {n}_{1}^{- 1} {\hat{f}}_{2} ( {X}_{1} ; {H}_{2} ) \\ = {n}_{1}^{- 1} \cdot {n}_{2}^{- 1} {\sum }_{i = 1}^{{n}_{1}} {\sum }_{j = 1}^{{n}_{2}} {K}_{{H}_{2}} ( {X}_{1} - {Y}_{j} )\end{matrix} & ( 11 )\end{matrix}$$

The asymptotic sampling distribution of the density test statistic function \hat{T} can be achieved by selecting parameters which fulfill the following conditions, for k=1,2:

(C1) The target density functions fₖ have two derivatives, which are bounded, continuous and square integrable.
(C2) The bandwidth matrices Hₖ=Hₖ(nₖ) are a sequence of symmetric positive definite matrices, such that all elements of both the bandwidth matrix Hₖ and the matrix defined by nₖ⁻¹|Hₖ|^{-1/2} tend towards zero when the number of sample data nₖ increases towards infinity.
(C3) The kernel function K is a symmetric probability density function such that the value ∫K(x)²dx is finite and that ∫xx^{T}K(x)dx=m₂(K)·I_{d}, wherein m₂(K) for is a real number and I_{d} is the d×d identity matrix.
(C4) The sample sizes (i.e. the number of sample data) n₁,n₂ are such that n₁/n₂ and n₂/n₁ are bounded away from zero and infinity when n₁ and n₂ increase towards infinity.

From such a density test statistic function \hat{T} which follows an asymptotic normal distribution, it is possible to compute an approximate normal score value Z, by using the following equation:

$$Z = \frac{\hat{T} - {\hat{μ}}_{T}}{\sqrt{{\hat{σ}}_{T}^{2} \cdot ( \frac{1}{{n}_{1}} + \frac{1}{{n}_{2}} )}} \qquad ( 12 )$$

### Wherein:

\hat{μ}_{T} is the mean value estimator of the density test statistic function \hat{T};
\hat{σ}_{T}² is the variance estimator of the density test statistic function \hat{T}.

In particular, as n₁ and n₂ tend towards infinity (i.e. as the number of sample data increases), the normal score value Z tends towards the normal distribution function N(0,1) with a mean value of zero and a variance of 1.

Once the normal score value Z has been computed, a p-value associated with this normal score value Z may be derived (step 300), for example by using a memorized standard normal distribution table.

Once derived, this p-value is compared (step 400) with a predetermined level of significance α, in order to determine a similarity between the two images Im1 and Im2.

More precisely, if the p-value is less or equal to this level of significance α, then it is determined that the two images are different. Otherwise, if the p-value is higher than this level of significance α, then it is determined that the two images are similar.

Such a level of significance α can be typically 0.1, or 0.05, but is not limited to these values. The lower the level of significance α is defined, and the higher is the certainty that a p-value below this level of significance α indicates that the null hypothesis Hyp₀ is not verified, and thus that the images Im1 and Im2 are not similar, i.e. different in other words.

Such a conclusion about the similarity of the compared images can be reflected by automatically providing a similarity parameter, which depends on the comparison of the p-value with the level of significance α, and thus is indicative of the similarity (or not) between the two images.

In particular, such a similarity parameter can consist, for instance, in a binary parameter taking two values “similar” or “not similar”, which are allocated respectively when the p-value is higher than, or equal to, the level of significance α and when the p-value is lower than the level of significance α, respectively. With such a similarity parameter, it is possible to obtain automatically a similarity parameter, which depends on the result of the image comparison and can be used in an automatic and industrialized process.

The above-described method of comparing images is thus performed without having to use bootstrap resampling. Such a method decreases thus the computational burden, when compared with known techniques of computational imaging statistical comparison, and is easily usable by non-expert in the field of statistics.

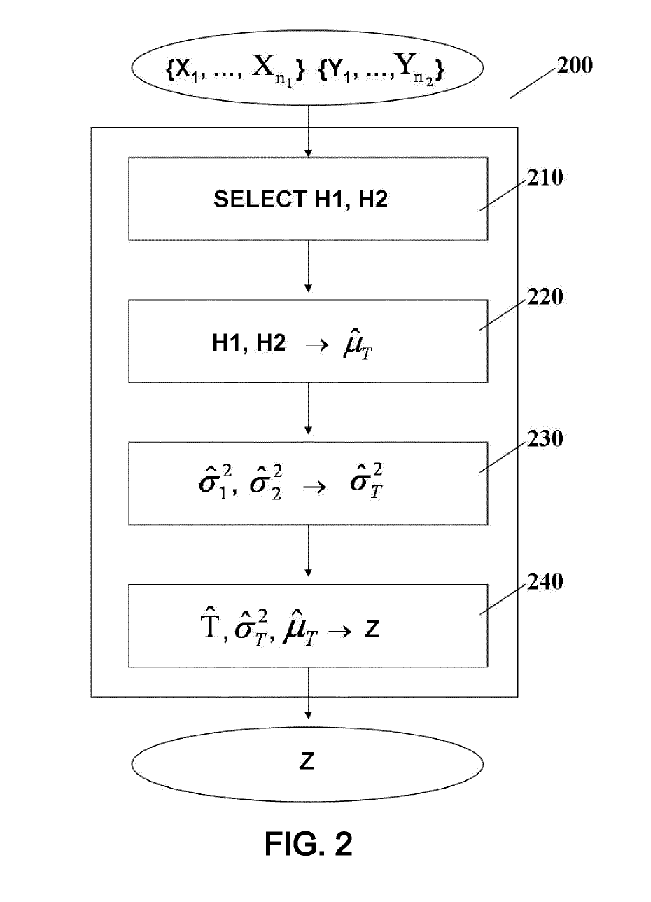

FIG. 2 shows a flow chart of an embodiment of the computation step 200 of the normal score value Z, based on the density test statistic function \hat{T} and the two samples of coordinate values, according to the present invention.

In this computation step 200, a first and a second optimal bandwidth matrices H₁, H₂, associated respectively with the first and second samples of coordinate values X₁, . . . , Xₙ_{₁} and Y₁, . . . , Yₙ_{₂}, are first selected (selection step 210).

Such bandwidth matrices consist advantageously in a sequence of symmetric positive definite matrices, in order to respect a certain number of conditions.

In particular, when the test statistic function \hat{T} is based on a first estimator \hat{ψ}₁, of a first integrated density functional \hat{ψ}₁ associated with the first sample of coordinate values X₁, . . . , Xₙ_{₁} and a second estimator \hat{ψ}₂ of a second integrated density functional ψ₂ associated with the second sample of coordinate values Y₁, . . . , Yₙ_{₂}, these first and second bandwidth matrices H₁,H₂ can be selected in order to minimize the mean square error respectively of the first and second estimators \hat{ψ}₁, \hat{ψ}₂ in the space of all symmetric positive definite matrices.

In other words, the optimal bandwidth matrix Hₖ (for k=1,2) is the minimizer of the mean squared error (MSE) defined as follows: MSE{\hat{ψ}ₖ(H)}=E[\hat{ψ}ₖ(H)−ψₖ]², wherein E[·] is the expectation operator.

This exact mean squared error being not always tractable, the optimal bandwidth matrix can also be defined as being the minimizer of the asymptotic MSE, i.e. H_{k,AMSE}=arg min_{HεF} AMSE{\hat{ψ}ₖ(H)}, where F is the space of all symmetric positive-definite matrices.

Once the two optimal bandwidth matrices H₁, H₂ have been selected, the mean value μ_{T} of the density test statistic function \hat{T} when the null hypothesis holds can be estimated (step 220) by using the following formula:

μ_{T}=E\hat{T}=(n₁⁻¹|H₁|^{-1/2}+n₂⁻¹|H₂|^{-1/2})·K(0) (13)

Here, in order to estimate such a mean value μ_{T}, an estimator \hat{μ}_{T} of this mean value μ_{T} is obtained by substituting the selected optimal bandwidth matrices H₁, H₂ into (13).

The variance Var\hat{T}=σ_{T}²(n₁⁻¹+n₂⁻¹) of the density test statistic function \hat{T} when the null hypothesis holds can also be determined at that stage (step 230).

The estimator of this variance can be used, such an estimator being defined according to the following the equation:

\hat{σ}_{T}²=(n₁·\hat{σ}₁²+n₂·\hat{σ}₂²)/(n₁+n₂) (14)

where \hat{σ}₁² is an estimator of σ₁², the variance of f₁(X), and \hat{σ}₂² an estimator of σ₂², the variance of f₂(Y).

When considering the first order Taylor's series expansion f₁(X) about its expected value:

f₁(X)˜f₁(EX)+(X−EX)^{T}Df₁(X) (15)

where Df₁ is the derivative of first order partial derivatives of f₁. Then, the variance of f₁(X) can be defined as follows:

σ₁²=Varf₁(X)˜[Df₁(EX)]^{T}(VarX)[Df₁(EX)] (16)

and likewise for the variance of f₂(X):

σ₂²=Varf₂(Y)˜[Df₂(EY)]^{T}(VarY)[Df₂(EY)] (17)

Respective variance estimators 61 and & of the first and second density functions can then be defined as follows:

\hat{σ}₁²=[D\hat{f}₁( X̅;Ĝ₁^{NS})]^{T}S₁[D\hat{f}₁( X̅;Ĝ₁^{NS})] (18)

\hat{σ}₂²=[D\hat{f}₂( Y̅;Ĝ₂^{NS})]^{T}S₂[D\hat{f}₂( Y̅;Ĝ₂^{NS})] (19)

### Wherein:

Sₖ are the sample variances for the k-th sample of coordinate values;
X̅ and Y̅ are the sample means of the respective first and second sample of coordinate values; and
Ĝₖ=[4/(d+4)]^{2/(d+6)}Sₖnₖ^{-2/(d+6)} are the normal scale selectors for a kernel estimator of the first density derivative of the k-th sample of coordinate values.

The variance estimators \hat{σ}₁² and \hat{σ}₂² in equation (14) can be then replaced by their value according to equations (18) and (19), in order to obtain the estimate of the variance \hat{σ}_{T}².

Once the mean value estimator \hat{μ}_{T} and the variance estimator \hat{σ}_{T}² of the density test statistic function \hat{T} have been determined, and knowing this density test statistic function \hat{T}, it is then possible to compute the normal score value Z (step 240) using previously mentioned equation (12).

The above-mentioned method of comparing images is thus able to determine if two images are similar or not, in a precise and simple manner which allows a completely automatic testing procedure and the monitoring by non-expert in the field of statistics.

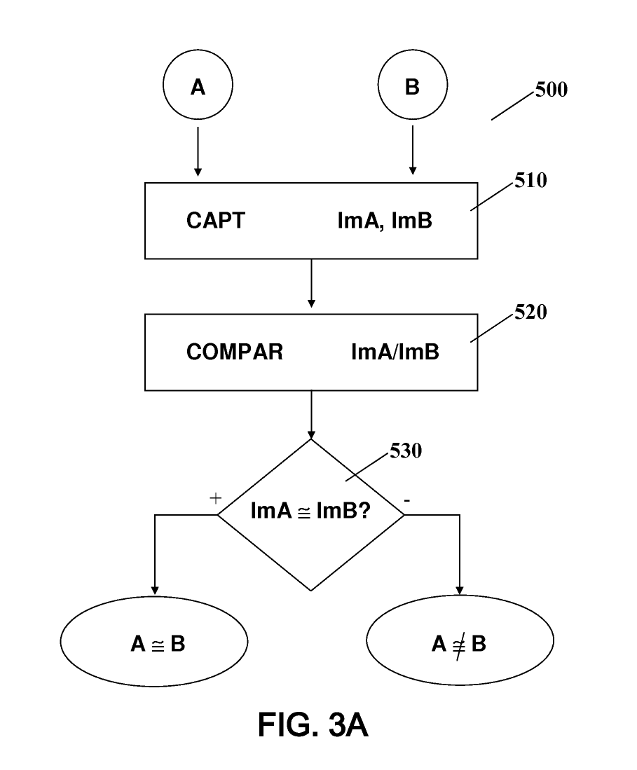

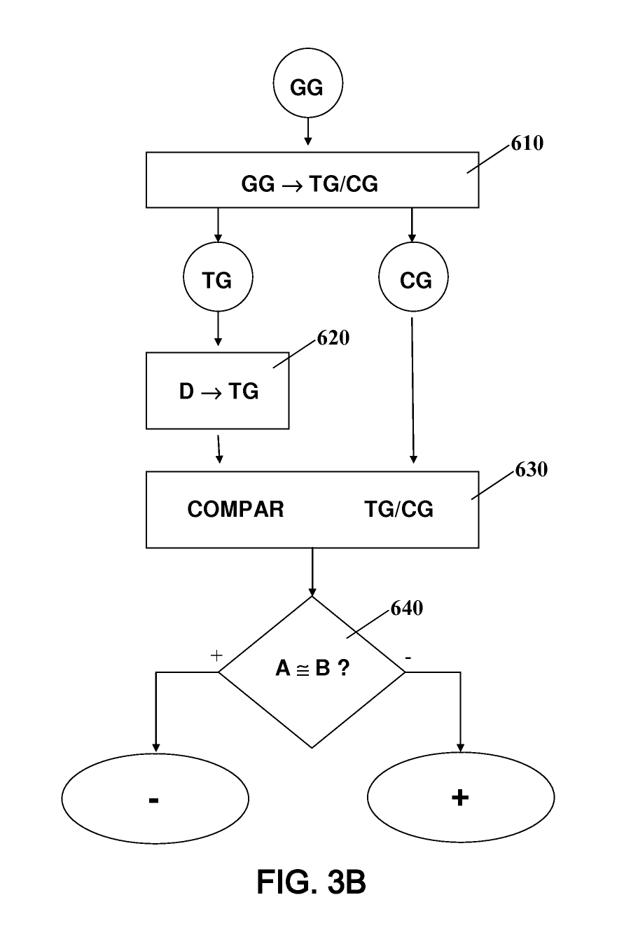

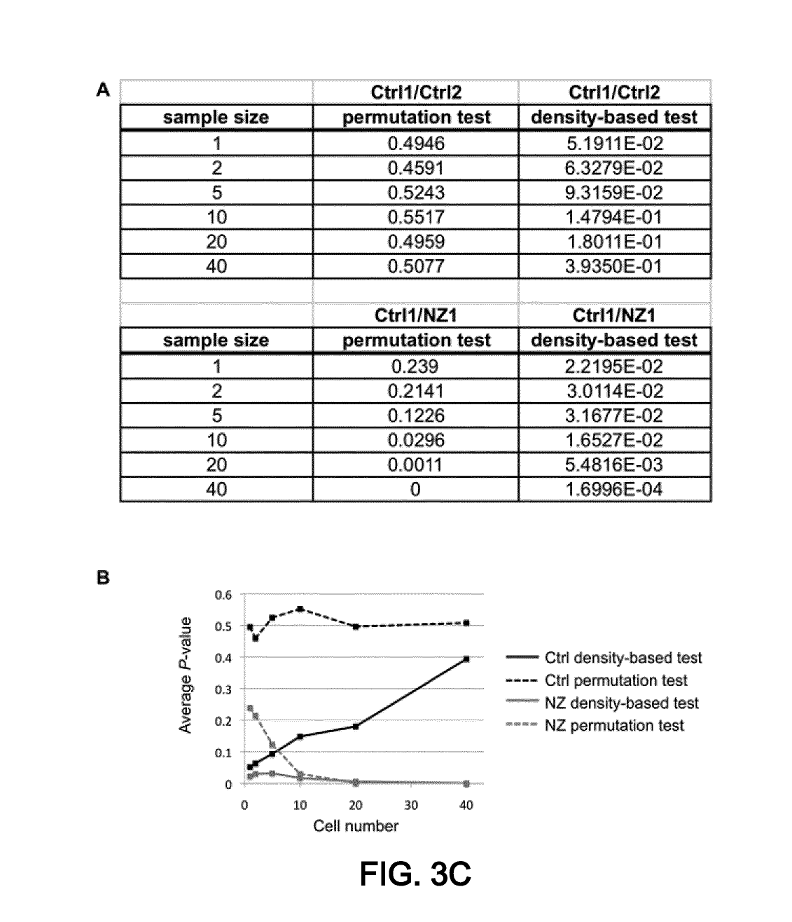

FIG. 3A shows a flowchart illustrating a general method for determining whether a cellular condition is similar or not to another cellular condition, using the above-mentioned density-based test.

In this method 500, at least one cell in a first cellular condition A and at least one cell in a cellular condition B are first provided.

Then, one (or more) image ImA of the cell in the first cellular condition A is captured, while one (or more) image ImB of the cell in the second cellular condition B is captured (step 510). Such images can be captured by using any biological imaging techniques known to those skilled in the art such as fluorescent microscopy.

The image(s) ImA and the image(s) ImB are then compared, by using the above-mentioned method of processing data for comparing images, in order to determine if these images are similar or not (step 520).

It is then determined whether the cellular condition A is similar to the cellular condition B, based on the result of this image comparison (step 530).

More precisely, if this comparison shows that images ImA and ImB are similar, then it is determined that the cellular condition A is similar to the cellular condition B. If this comparison shows that images ImA and ImB are not similar, then it is determined that the cellular condition A is not similar to the cellular condition B.

Such a general method can be embodied in various specific methods wherein it is necessary to compare cells or groups of cells.

FIG. 3B shows a flowchart of such a method applied for determining the influence of a compound on a biological structure, using the method of processing data for comparing images according to the present invention.

In this method, a first and second groups TG and CG of elements of the biological structure to be studied are first provided (step 610), for instance from a global group GG of elements of this biological structure and gathering these chosen elements in the first group TG while gathering the other not-chosen elements in the second group CG.

The compound D, whose influence on the biological structure is to be determined, is then applied only on all the elements of the first group TG (step 620), which can be thus also designated as being the “treatment group”.

The other group CG designates thus here a reference “control group” of elements of the same biological structure. Such control group does not receive the compound D. It might receive either no compound or a reference compound against which compound D needs to be assessed. (A control compound can be applied on both groups.)

Once the compound D has been applied on the first group TG, one or more cell(s) belonging to the first group TG and one or more cell(s) belonging to the second group CG are selected and used to determine if the cellular condition of the first group TG is similar to the cellular condition of the second group CG (step 630), by using the previously described method illustrated in FIG. 3A.

Once the similarity, or the absence of similarity, of the cellular conditions of the two groups of cells TG and CG have been determined, it is possible to derive if the compound D has an influence on the biological structure under study (step 640).

If it is determined that the cellular conditions of the two groups of cells TG and CG is similar, then it can be concluded that this compound D has no influence on the biological structure. On the contrary, if it is determined that the cellular conditions of the two groups of cells TG and CG are not similar, then it can be concluded that this compound D has indeed an influence on the biological structure.

The compound D can be a null compound by which we mean that either no compound is applied to the first group TG or the compound is applied to both groups. In this case, the aim is typically to establish a negative control experiment, that is, to identify correctly that the images Im1 and Im2 in this case are similar. Typically several tens of cells are analyzes to warrant statistical significance.

FIG. 3C illustrates a comparison of the p-value obtained with the method of the present invention and the prior art method which uses a resampling technique.

In particular, part A of FIG. 3C shows tables including average p-values of permutation and 3D KDE-based test statistics from 100 comparisons, in which corresponding number of cells were picked randomly from 100 cells among a control group Ctrl or 66 NZ-treated cells.

Such a comparison was realized to see how a test based on the method of the present invention can perform in comparison to a resampling strategy which was previously established for the comparison of fluorescent images.

Average p-values were calculated respectively from either the permutation analysis based on a resampling strategy or from the density-based test statistics of the present invention, as a function of the number of cells analyzed, taking 100 random samples of 1, 2, 10, 20 and 40 cells.

Two random disjoint sub-samples Ctrl1 and Ctrl2 of coordinate values were drawn from the control group Ctrl to estimate the false positive rate of our test. On the other hand, a random sub-sample from the control group was compared with a random sub-sample from the treated group NZ1.

The results are given in the tables shown in part A of FIG. 3C and illustrated in the graph shown in part B of FIG. 3C, wherein the dashed lines correspond to the results obtained with the prior art permutation test, and the solid lines correspond to the results obtained with the density-based test of the present invention, as a function of the number of cells analyzed for 100 comparisons.

According to the fundamentals of p-value calculations, p-values follow a uniform distribution on [0, 1] and thus has a mean value of 0.5, assuming the null hypothesis holds, i.e. for the control group CG. This is true for the permutation test since it can mimic the sampling distribution of the test statistic.

With respect to the comparison of sub-samples Ctrl1 and Ctrl2, it can be seen that, with the density-based test of the present invention, the asymptotic approximation gives smaller average p-values, thus potentially more false positives, for less than 40 cells than the permutation test. However, average p-values remain larger than 0.05 are obtained with 5 cells, so the rate of false positives is mitigated.

With respect to the comparison of control sample Ctrl1 with nocodazole treated sample TNZ1, the density-based test gives lower p-values, thus more true positives, that the permutation test for a number of cells smaller than 10.

It can be seen that these two tests will give the same conclusions when testing a treatment for more than 10 cells, thus demonstrating that the normal approximation for the sampling distribution used in the density-based test of the present invention is as accurate as bootstrap resampling used in permutation test, and thus is well suited to detect changes in steady state

### Applications of the Data Processing Method of the Invention

The method according to the invention, also referred to as a density-based test, can be used in various technical fields wherein there is a need to determine differences between high content images and to quantify such differences including but not limited to the biology field. Potential applications outside of biology are in astronomy, e.g. comparison of positioning of stars; geography, e.g. comparison of landscape changes over time, network analyses, e.g. comparison of traffic patterns over time; quality control in microchips, e.g. comparison of a chip design in comparison to a reference and other fields in which complex (multidimensional) spatial patterns need to be compared or analyzed.

The method according to the invention has strong advantages. Indeed, thanks to the method of the invention, it is possible to compare any type of images with high and complex contents, in a fast, automated and unbiased way, since all parameters required for the test statistic are estimated from the data. As information is not reduced to smaller dimension or summary statistics (e.g. spatial 3D organization is reduced to 1D information such as mean distance), the detection of changes is more sensitive that classical approaches.

Particularly, the applications in the biology field are numerous. Basically, the methods according to the invention can be used each time there is a need to detect whether there is a change in a biological structure.

### Biological Structures to be Studied

Within the meaning of the invention, a “biological structure” refers either to a group of cells within a tissue, an isolated cell, intracellular compartments including cell organelles (e.g. chloroplast, endoplasmic reticulum, Golgi apparatus, mitochondria, vacuole, nucleus, ribosome, cytoskeleton, flagellum, cilium, centriole or microtubule-organizing center (MTOC), multivesicular bodies (MVB), late endosomes, endocytic carrier vesicle), membrane domains (e.g. endoplasmic reticulum exit sites (ERES), nuclear pore complexes), a nuclear compartment (e.g. nucleoli, transcription sites), or other cell component such the cytoskeleton including microfilaments, microtubules and intermediate filaments; proteins or nucleic acids with defined function (biomarker). In order to study such cells or intracellular components, the herein-mentioned methods advantageously comprise an additional step of visualizing said biological structure with an appropriate marker, said marker being specific of said biological structure of interest.

Within the meaning of the invention, a “change in a biological structure” refers either to a morphological change or to a molecular change.

Typically, a “morphological change” refers for instance to a change in the inner architecture of a biological structure, or to a change in the overall morphology of a biological structure.

Typically, a “molecular change” refers for instance to a change in the molecular signaling inside a biological structure.

In one embodiment, the method according to the invention is used for detecting a change in the inner architecture of a biological structure. By “architecture” it is meant the spatial organization of the constituents of the biological structure, said constituents being for example the cytoskeleton, the organelles, etc. By specifically marking or staining one or more cellular constituents that need to be studied, the method according to the invention permits to detect a change in this (these) constituent(s). The marking or staining of the constituents of the cells can be performed by any classical methods well know in the art, such as indirect immunofluorescence, histology staining, genetic tagging of proteins of interest, posttranslational modifications of proteins with fluorophors, fluorescence in situ hybridization (fish) of nucleic acids or any other method.

In another embodiment, the method according to the invention is used to detect a change in the overall morphology of a biological structure. By “morphology” it is meant the structural features of cells and the topological relationships between biological structures. In order to study the morphology of a biological structure, it is advantageous to either normalize different biological structures that need to be compared due to a reference structure that is not changing or to compare the same biological structures at different time points. For instance, when comparing independent biological structures, the volume, in which all biological structures are localized, need to be similar. When comparing changes of the same biological structure, the time interval of monitoring changes needs to be chosen. By using the method according to the invention, the changes in the morphology of the biological structure are detectable.

In another embodiment, the method according to the invention is used to detect a change in the molecular signaling inside a biological structure. The molecular signaling can be for instance studied by visualizing a compound involved in a signaling pathway (either in an intracellular signaling pathway or an extracellular signaling pathway) or epigenetic modifications e.g. by marking a posttranslational modification of this cellular component including but not limited to phosphorylation, adenylation, methylation, acetylation, SUMOylation, ubiquitination of molecules, etc. By using the methods according to the invention, it is also possible to detect a change in the topology of intracellular signaling pathways or epigenetic modifications.

In the methods of the invention, when the biological structure is a cell, a group of cells or a cell component, any type of cell can be used. The cells can be prokaryotic or eukaryotic.

In a particular embodiment, the cells are unconstrained. They can be studied in live-cell assays. In another particular embodiment, the cells are constrained cells whose form is predefined by external factors, i.e. cells grown in tissues or on a specifically shaped pattern such as micro-patterns allowing controlling cell overall morphology and/or cellular inner architecture. Several means of constraining cells are known to those skilled in the art including micro-patterns described in U.S. Pat. No. 5,470,739; Kam et al. Biomaterials 20:2343-2350 (1998); Grybowski et al. Analytical Chemistry 70:4645-4652 (1998); Branch et al. Medical and Biological Engineering and Computing 36:135-141 (1998); Teixerira et al. J. Cell Science 116:1881-1892 (2003); Gopalan Biotech. Bioeng. 81:578-:587 (2003); Itoga et al. Biomaterials 25:2047-2053 (2004); U.S. Pat. No. 6,368,838; WO01/70389; WO02/86452; WO02/22787; WO2004/069988; WO03/080791; Clark J. CellScience 103:287-292 (1992); WO2005/026313 and in Thery et al. Nature Cell Biology 7:947-953 (2005). Of particular interest are constrained cells, such as disclosed in WO2005/026313 and in Thery et al. (2005), wherein the operator has a precise control of focal adhesions distribution in cells using anisotropic adhesive patterns to which only one cell can adhere and which are either concave or have a long and thin adhesive area with a shape factor of less than 0.6 as defined in WO2005/026313. In such constrained cells, the intracellular distribution of organelles is controlled, i.e. is the same in a group of cells in the same biological situation and constrained with the same micro-pattern, thereby facilitating the detection of changes inside the cells by the methods according to the invention.

In particular embodiments, healthy cells are compared to diseased cells. Such cells can be infected by pathogens, e.g. cells infected by a virus, bacteria, fungi or parasites, or show intrinsic miss-regulation in cell function such as cancer cells.

In particular embodiments, reference cells can be compared to whose cells in which cellular components are either over-expressed or down-regulated. The down-regulation of cellular components is regularly applied in siRNA knock out screens.

Applications Wherein there is a Need to Detect a Change in a Biological Structure

Changes in a biological structure are typically detected by studying said biological structure in a reference situation and then in another situation.

Hence, in the methods according to the invention, when a first biological structure is compared to a second biological structure, it should be understood that the first and second biological structures are of the same type, but have been subjected to different situations (e.g. the same type of cell subjected to two different treatments) and/or have a different origin (e.g. a immune cell of the spleen and the same type of cell of a lymph node) or have been obtained from different patients (e.g. the same type of cell obtained from a healthy and a sick patient).

By comparing images of the biological structures in the two situations by using a method according to the invention, it is possible to detect the changes in the structures. It is considered to have a “change” in the biological structure when the method according to the invention leads to the detection of a statistical difference in the images of the biological structures in the two situations.

Typically, the images of the biological structures are captured by using any biological imaging techniques known to those skilled in the art. The biological structures can be, for instance, visualized by bioluminescence imaging, calcium imaging, diffuse optical imaging, diffusion-weighted imaging, fluorescence lifetime imaging, gallium imaging, magnetic resonance imaging (MRI), medical imaging, microscopy, molecular imaging, optical imaging, ultrasound imaging, etc. Once the biological structures are visualized, images of those structures can be captured, for example by a camera. Microscopy techniques are particularly suitable for visualizing biological structures. Any type of microscopy technique can be used, depending on the biological structure to be studied. A particularly advantageous technique is fluorescence microscopy, as it can be extremely sensitive, allowing the detection of up to single molecules. Many different fluorescent dyes can be used to visualize different biological structures. One particularly powerful method is the combination of antibodies coupled to a fluorophore as in immunostaining. Examples of commonly used fluorophores are fluorescein or rhodamine. The antibodies can be made tailored specifically for a chemical compound.

Typically, the changes are detected between a reference biological situation and another biological situation. For example, the methods according to the invention are typically used to detect the changes induced by a condition (e.g. temperature, oxygen, environmental stress, etc.) or by a compound on a cell or group of cells. By “compound” it is, meant any type of compound thought to have a biological effect including but not limited to a small organic or inorganic molecule, a protein, a peptide, an aptamer, a nucleic acid molecule (DNA, RNA, etc.) including interfering RNA such as siRNA. Additionally, the invention is used to detect the changes induced by a pathogen (virus, bacteria, and more generally any type of microorganism) or another biological structure.

The methods according to the invention can thus be for instance used for comparing a test compound with a compound of reference, such as in drug screening methods, to compare the influence of various doses of a given compound, to detect the presence of an intracellular pathogen, to assess cytotoxicity of test compounds, to monitor the response of patients to a treatment, etc.

### Particular Embodiments of the Method According to the Invention Applied to the Biological Field

The above-mentioned method of determining the influence of a compound on a biological structure, based on the previously described density-test method of comparing images, can be used in many applications.

An object of the invention is thus a method for detecting a change between a first biological structure A and a second biological structure B, this method comprising the step of comparing an image ImA of the first biological structure A to an image ImB of the second biological structure B using the method according to the invention, wherein a change is detected when the image ImA of the first biological structure A and the image ImB of the second biological structure B are not found similar by said method according to the invention.

In an embodiment of this method for detecting a change, the first biological structure A has not been subjected to a compound D and the second biological structure B has been subjected to a compound D, and the detection of change between the first biological structure A and the second biological structure B is indicative of an effect of said compound D on the biological structure.

In another embodiment of said method for detecting a change, the first biological structure A has been subjected to a first amount of a compound D and the a second biological structure B has been subjected to second amount of a compound D, different from the first amount, and the detection of change between the first biological structure A and the second biological structure B is indicative of an effect of the amount of said compound D on the biological structure.

In another embodiment, said methods for detecting a change are used in methods for screening compounds. Methods of the invention are particularly useful in the context of high-throughput screening processes with high content analysis. They can also be used in genome-wide screening by inactivation of individual genes by siRNA.

In another embodiment of said methods for detecting a change, said effect is a therapeutic effect and/or a cytotoxic effect. Cytotoxicity can be for instance evaluated by detecting cellular morphological changes indicative of apoptosis. The following non limitative cellular morphological changes in apoptosis can be detected by the methods according to the invention: cell shrinkage and rounding resulting from the breakdown of the proteinaceous cytoskeleton by caspases; the cytoplasm appears dense; the organelles appear tightly packed; chromatin undergoes condensation into compact patches against the nuclear envelope (pyknosis); the nuclear envelope becomes discontinuous and the DNA inside is fragmented (karyorrhexis); the nucleus breaks into several discrete chromatin bodies or nucleosomal units due to the degradation of DNA; the cell membrane shows irregular buds known as blebs; the cell breaks apart into several vesicles called apoptotic bodies.

In another embodiment of said method for detecting a change, the first biological structure A has been obtained from a patient suffering from a disease before the beginning of a treatment of the disease or in course of said treatment, and the second biological structure B has been obtained from the same patient subsequently in course of said treatment, and the absence of detection of a change between the first biological structure A and the second biological structure B is indicative of resistance of the patient to said treatment. Typically, in such an embodiment, an image of the biological structure to be tested is captured before the beginning of the treatment. Other images of the same biological structure are then captured in course of the treatment. The images are then compared by the method according to the invention in order to determine whether or not a change has occurred in the biological structure in course of treatment.

For example, if the treatment is a chemotherapeutic treatment for treating a breast cancer in a patient, the biological structure to be studied could be for example a breast cell obtained from a breast cancerous tissue of the patient, either compared to a breast cell obtained from a non cancerous breast tissue of the patient, or to a reference/control breast cell known as non cancerous If a change in the morphology of the breast cancer cell in course of treatment from a “cancerous cell morphology” to a “non cancerous cell morphology” is detected by the method according to the invention, this would be indicative of responsiveness of the patient to the chemotherapeutic treatment.

In another embodiment of said method for detecting a change, the first biological structure A has been obtained from a patient suffering from a disease, and the second biological structure B has been obtained from a patient to be diagnosed, and the absence of detection of a change between the first biological structure A and the second biological structure B is indicative that the patient to be diagnosed suffers from said disease. In such embodiment, the biological structure to be investigated is relevant to the disease to be diagnosed. Any disease known or thought to induce changes in biological structures could be diagnosed using the methods of the invention including but not limited to cancer diseases, neurodegenerative diseases, renal cystic disease and other diseases with typical changes in the cytoarchitecture. Furthermore, infection by pathogens that change cellular trafficking pathways could be detected.

In another embodiment, the method according to the invention is used for establishing fingerprints of biological structures, e.g. cells or cell compartments, in specific situations of interest (e.g. cancer, infection, . . . ). Such fingerprints are particularly useful in diagnostic methods. For instance, by analyzing different images of cancerous cells, the method according to the invention is suitable for determining the morphological structures which are specific of cancerous cells and could thus serve as a basis of a fingerprint of said cancerous cells. Fingerprints of different cancer diseases could possibly be established that would allow discriminating between different cancer types. Once such fingerprint is determined and recorded as “reference image”, new images of cells suspected of being cancerous can then be compared to the fingerprint. In case the images of the fingerprint and the cells are similar, the cells can thus be considered cancerous.

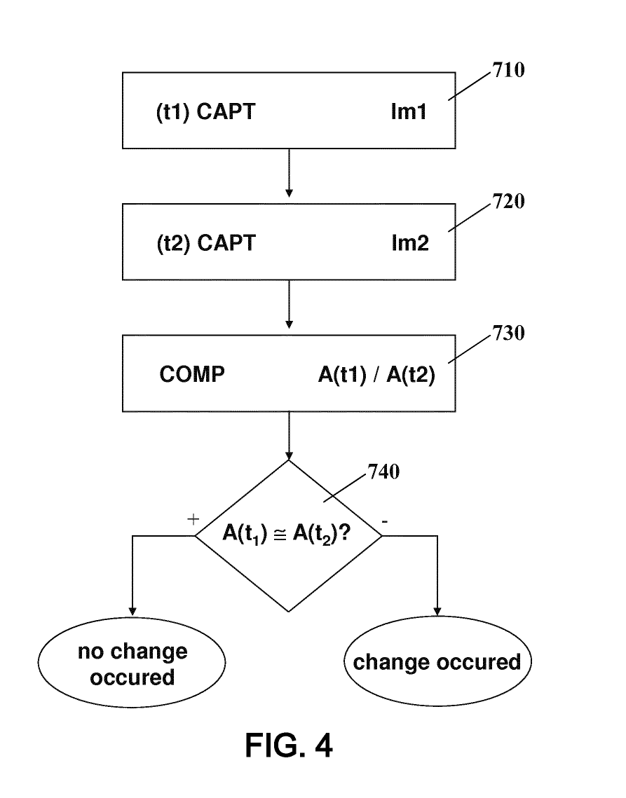

FIG. 4 shows a flowchart of a method for detecting changes over time of a biological structure, which uses the method of processing data for comparing images according to the present invention.

In this method, at least one first image Im1 of the biological structure to be studied is acquired, at a first instant t₁, via a biological imaging means (step 710).

Later on, at least one second image Im2 of the biological structure to be studied is acquired, at a second instant t₂, via the same biological imaging means (step 720).

Once these two images are available, they can be compared (step 730) by the method according to the invention in order to determine (step 740) whether the biological structure at the first instant (denoted A(t₁)) is similar to the biological structure at the second instant (denoted A(t₂)). More precisely, if it is determined that the biological structures A(t₁) and A(t₂) are similar, then it can be concluded that no change has occurred between instants t₁ and t₂. On the other hand, if it is determined that the biological structures A(t₁) and A(t₂) are not similar, it can be concluded that a change has occurred between instants t₁ and t₂.

### Products Embodying the Data Processing Method of the Invention

The invention also relates to a computer program product that is able to implement any of the steps of the method of comparing images as described above when loaded and run on processing means of an analyzing device. The computer program may be stored/distributed on a suitable medium supplied together with or as a part of other hardware, but may also be distributed in other forms, such as via the Internet or other wired or wireless telecommunication systems.

The invention further relates to an analyzing device for detecting morphological changes in a biological structure, such as for example cell or a more specific compartment in a predetermined type of cell.

This analyzing device comprises image acquiring means able to capture a first image Im1 of a biological structure and a second image Im2 of the biological structure. Such image acquiring means can be implemented as a fluorescent microscope.

This analyzing device comprises also processing means, such as a microprocessor, which receive the captured images and compare these images by performing the steps of the above-mentioned method of comparing images.

In particular, these processing means extract a first sample of coordinate values X₁, . . . , Xₙ₁ from the first image Im1 and a second sample of coordinate values from the second image Im2, compute a normal score value Z based on a density test statistic function \hat{T} applied on the first and second samples of coordinate values, such a density test statistic function \hat{T} having an asymptotic distribution as described previously, and compare a p-value, derived from the computed normal score value Z, with a predetermined level of significance α in order to determine a similarity between the first and second images.

Such an analyzing device can be used for instance for determining the influence of a compound on a biological structure especially in high-throughput screening processes, monitoring a drug treatment comprising one or more specific treatment compound(s), assessing the cytotoxicity of a predetermined compound on a biological structure or detecting morphological changes in a biological structure over time, as described previously.

The devices according to the invention have the advantages of rendering possible to acquire data in a fast and automatic manner. A typical application of the devices of the invention is the automatic analysis of data collected from multiwell plates, e.g. 96 well plates.

### EXAMPLES

In order to illustrate such a method for determining whether one cellular condition is similar or not to at least another cellular condition we provide more specific examples describing experimental studies of eukaryotic cells. In the following description, all experiments for which no detailed protocol is given are performed according to standard protocols.

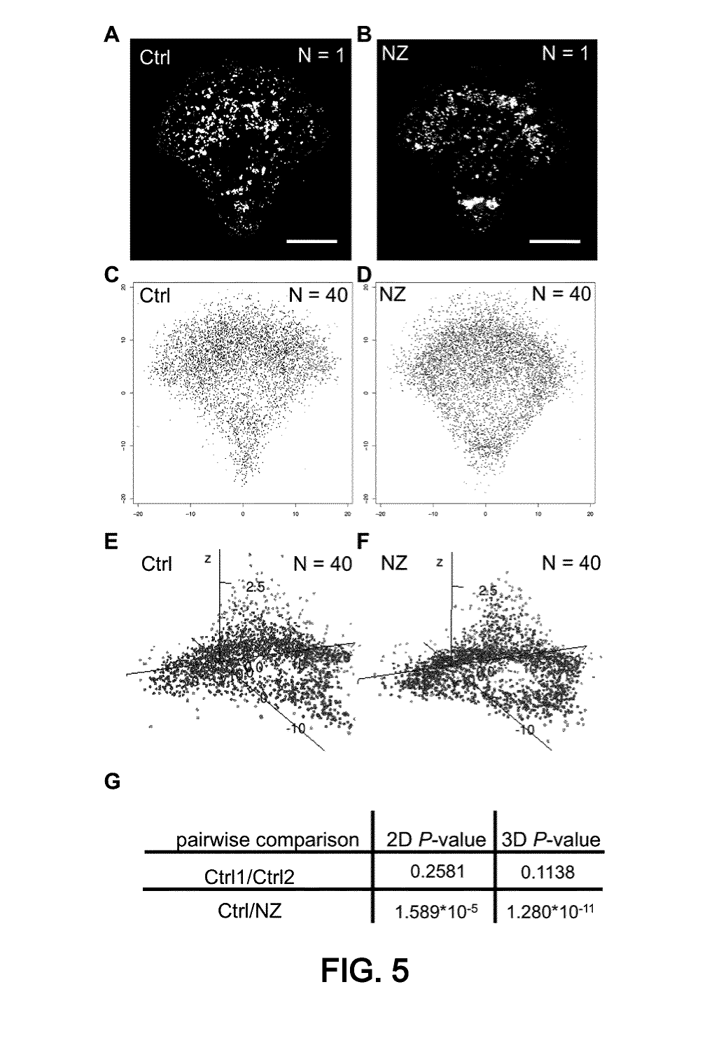

FIGS. 5, 6 and 7 illustrate respectively three different examples No. 1, No. 2 and No. 3 of experimental studies.

In these examples, one determines the influence of a compound on different biological structures using the above-described method. In these examples, the morphologies of several intracellular structures were compared in the presence and absence of a compound (nocodazole) that depolymerizes microtubules, a major component of the cellular cytoskeleton.

In example No. 1 illustrated on FIG. 5, multivesicular bodies (MVB) from the CG (represented by Im1) and the TG after addition of the drug nocodazole (represented by Im2) are compared, in order to determine the influence of this drug on dispersed organelles in eukaryotic cells.

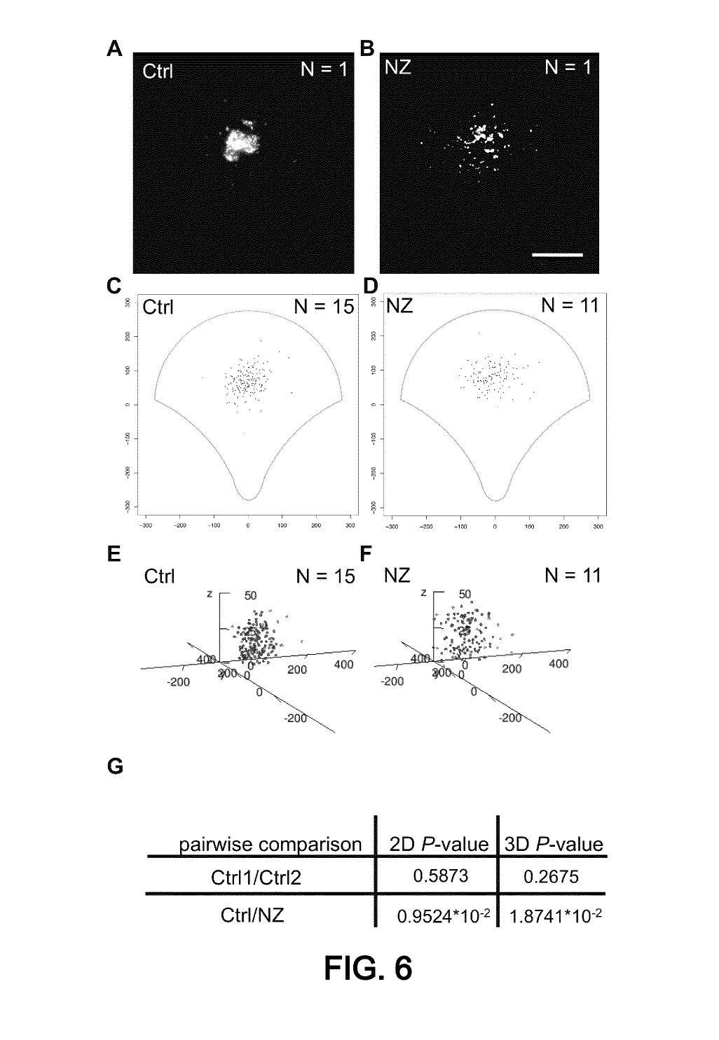

In example No. 2 illustrated on FIG. 6, the morphology of the Golgi apparatus from the CG (represented by Im1) and the TG after addition of the drug nocodazole (represented by Im2) are compared, in order to determine the influence of this drug on a compact organelle in eukaryotic cells.

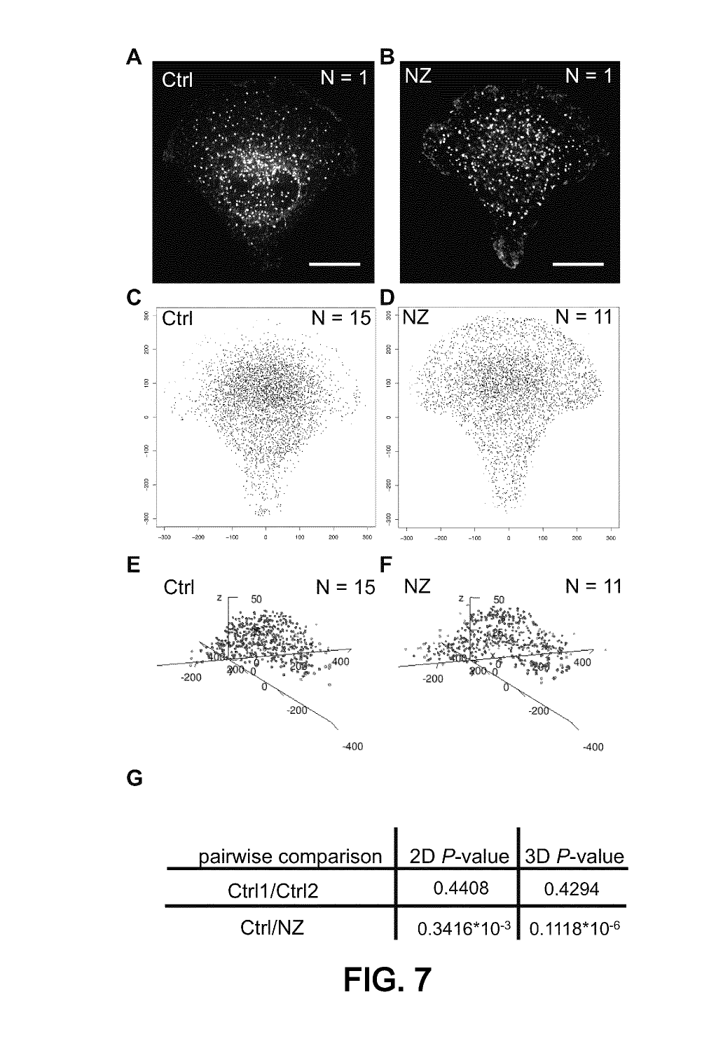

In example No. 3 illustrated on FIG. 7, endoplasmic reticulum exit sites (ERES) from the CG (represented by Im1) and the TG after addition of the drug nocodazole (represented by Im2) are compared, in order to determine the influence of this drug on specific membrane domains in eukaryotic cells.

### Material and Methods

Human RPE-1 cells kept in growth medium were trypsinized and seeded on micropattern-printed coverslips as described in EP 1664266. To depolymerize microtubules, nocodazole was added to a final concentration of 10 μM to TG. TG and CG were both subsequently incubated for 1 h at 4° C. and 1 h at 37° C. Cells were fixed with 4% (wt/vol) paraformaldehyde (PFA) and proceeded for indirect immunofluorescence staining with primary α-CD63 antibodies (Invitrogen) to visualize MVB, α-GM130 antibodies to visualize the Golgi apparatus and α-Sec13 antibodies to visualize ERES as well as fluorophore-coupled secondary antibodies. 3D image stacks of n cells of each condition (TG and CG) were acquired with 100× magnification and Z-series every 0.2 μm. Images were deconvolved and segmented in order to detect signals that are fifteen-fold larger than noise. The coordinates of the segmented structures from all cells were aligned using the micropattern geometry and the coordinate sample of the TG was compared with the coordinate sample of the CG using the above-described method for each intracellular compartment analyzed.

### Results

### Example No. 1

Parts A and B of FIG. 5 illustrate representative fluorescent images of one cell from CG (designated by “Crtl”) and one cell from TG (designated by “NZ” for nocodazole) stained for MVB. Intracellular MVB were visualized by detecting CD63, a transmembrane protein enriched on MVB by indirect immunofluorescence in the presence and absence of nocodazole. As shown in prior art, the steady-sate three-dimensional organization of MVB is constant in micropatterned cells as analyzed here.

Parts C,D and E,F of FIG. 5 illustrate two-dimensional (C,D) and three-dimensional (E,F) scatter plots of the aligned coordinates obtained after the segmentation analysis. Each coordinate stands for one segmented CD63-marked structure. The scatter plots in C,E represent the entire MVB sample (11786 detected structures) from 40 cells of CG, while the scatter plots in D,F represent the entire MVB sample (13615 detected structures) from 40 cells of TG.

Once obtained, the coordinate values of the CG and TG were compared using the density-based method of the present invention. The results for the comparison TG/CG give p-values of P_{2D}-value=1.589*10⁻⁵ and P_{3D}-value=1.280*10⁻¹¹, well below a typical significance level of 0.05 or 0.01, which is a very strong and reliable indication that both samples Im1 and Im2 are different. Thus, we conclude that nocodazole-affects significantly the cellular morphology of MVB.

Additionally, we performed a negative control experiment, in which we compared MVB from the same CG (here called CG1) with MVB from a second disjoint control group (CG2) of 40 cells with 12585 detected structures.

The coordinate values of the CG1 and CG2 were compared using the density-based method of the present invention. The results for the comparison CG1/CG2 give p-values of P_{2D}-value of 0.2581 and P_{3D}-value=0.1138, well above typical significance levels of 0.05 or 0.01. This is a very strong and reliable indication that both samples are similar, and thus that the differences between these control groups are not biologically significant i.e. there are no morphological differences.

### Example No. 2

Parts A and B of FIG. 6 illustrate representative fluorescent images of one cell from CG (designated by “Crtl”) and one cell from TG (designated by “NZ” for nocodazole) stained for the Golgi apparatus. The Golgi apparatus was visualized by detecting GM130, a specific Golgi marker, by indirect immunofluorescence in the presence and absence of nocodazole.

Parts C,D and E,F of FIG. 6 illustrate two-dimensional (C,D) and three-dimensional (E,F) scatter plots of the aligned coordinates obtained after the segmentation analysis. Each coordinate stands for one segmented GM130-marked structure. The scatter plots in C,E represent all segmented structures of the Golgi apparatus from 15 cells of CG, while the scatter plots in D,F represent all segmented structures of the Golgi apparatus from 20 cells of TG.

Once obtained, the coordinate values of the CG and TG were compared using the density-based method of the present invention. The results for the comparison TG/CG give a P_{2D}-value=0.9524*10⁻² and P_{3D}-value=1.8741*10⁻², well below a typical significance level 0.05 (but not 0.01), which is a strong indication that both samples Im1 and Im2 are different. Thus, we conclude that nocodazole affects significantly the cellular morphology of the Golgi apparatus.

Additionally, we performed a negative control experiment, in which we compared the Golgi apparatus from the same CG (here called CG1) with the Golgi apparatus from a second disjoint control group (CG2) of 11 cells.

The coordinate values of the CG1 and CG2 were compared using the density-based method of the present invention. The results for the comparison CG1/CG2 give a P_{2D}-value of 0.5873 and P_{3D}-value=0.2675, well above typical significance levels of 0.1 or 0.05. This is a very strong and reliable indication that both samples are similar, and thus that the differences between these control groups are not biologically significant i.e. there are no morphological differences.

### Example No. 3

Parts A and B of FIG. 7 illustrate representative fluorescent images of one cell from CG (designated by “Crtl”) and one cell from TG (designated by “NZ” for nocodazole) stained for ERES. ERES were visualized by detecting Sec13, a protein localizing to ERES, by indirect immunofluorescence in the presence and absence of nocodazole.

Parts C,D and E,F of FIG. 7 illustrate two-dimensional (C,D) and three-dimensional (E,F) scatter plots of the aligned coordinates obtained after the segmentation analysis. Each coordinate stands for one segmented Sec13-marked structure. The scatter plots in C,E represent all segmented structures of ERES from 15 cells of CG, while the scatter plots in D,F represent all segmented structures of ERES from 11 cells of TG.

Once obtained, the coordinate values of the CG and TG were compared using the density-based method of the present invention. The results for the comparison TG/CG give a P_{2D}-value=0.3416*10⁻³ and P_{3D}-value=0.1118*10⁻⁶, well below a typical significance level of 0.05 and 0.01, which is a very strong and reliable indication that both samples Im1 and Im2 are different. Thus, we conclude that nocodazole affects significantly the cellular morphology of ERES.

Additionally, we performed a negative control experiment, in which we compared ERES from the same CG (here called CG1) with ERES from a second disjoint control group (CG2) of 11 cells.

The coordinate values of the CG1 and CG2 were compared using the density-based method of the present invention. The results for the comparison CG1/CG2 give a P_{2D}-value of 0.4408 and P_{3D}-value=0.4294, well above typical significance levels of 0.05 or 0.01. This is a very strong and reliable indication that both samples are similar, and thus that the differences between these control groups are not biologically significant i.e. there are no morphological differences.

The above-mentioned method for determining the influence of a compound on several specific types of biological structures, such as intracellular compartments, can be used for monitoring the effects of drugs comprising one or more treatment compound(s). In the case, in which P-values are below typical significance levels, it can be concluded that a drug affects the biological sample. In the case, in which P-values are above typical significance levels, it can be concluded that a drug has no influence on a biological sample.

### Example No. 4

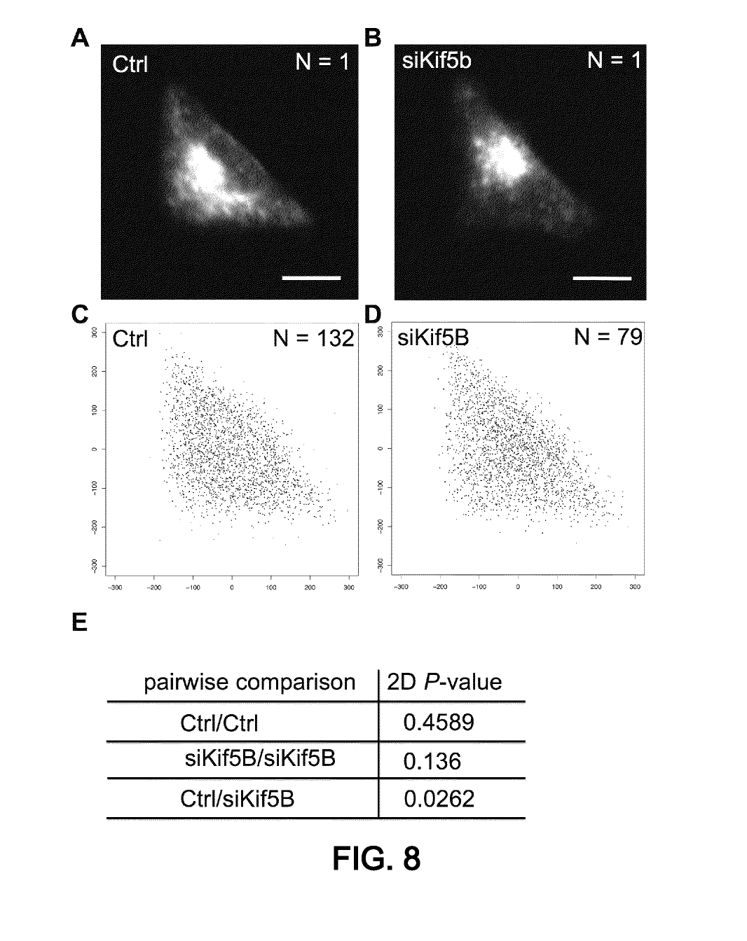

FIG. 8 illustrates another example No. 4, wherein the influence of gene knocks down on biological structures is determined using the above-described method.

In this example, the morphologies of intracellular structures were compared in conditions in which the expression level of a protein (here a motor protein) was modified by siRNA, in order to demonstrate that the density-based test can be used to detect morphological changes due to modifications in expression level of cellular components.

### Material and Methods

Human RPE-1 cells were transfected with siRNAs targeting a control gene (luciferase, representing CG) and Kif5B (representing TG) using standard protocols. After three days of knock down, cells were trypsinized and seeded on micropattern-printed coverslips as described in EP 1664266. Cells were fixed with 4% (wt/vol) paraformaldehyde (PFA) and proceeded for indirect immunofluorescence staining with primary α-CD63 antibodies (Invitrogen) to visualize MVB as well as fluorophore-coupled secondary antibodies. Samples were prepared as duplicates. The coordinate samples between the duplicates were compared, representing control conditions.

Images of n cells of each condition (TG and CG) were acquired with 20× magnification as typically performed in high-throughput screening experiments (only 2D). Images were segmented in order to detect signals over noise. The coordinates of the segmented structures from all cells were aligned using the micropattern geometry and the coordinate sample of the TG was compared with the coordinate sample of the CG using the above-described method for each intracellular compartment analyzed. The coordinate samples between the duplicates were compared, representing control conditions.

### Results

Parts A and B of FIG. 8 illustrate representative fluorescent images of one cell from CG (designated by “Crtl”) and one cell from TG (designated by “Kif5B”) stained for MVB. In this example, we effect of low Kif5B protein level on the morphology of MVB were analyzed in order to better understand the function of Kif5B in transport of MVB.

Parts C,D FIG. 8 illustrate the 2D scatter plots of the aligned coordinates obtained after the segmentation analysis. Each coordinate stands for one segmented CD63-marked structure. C represents the entire MVB sample from 132 cells of CG, while the scatter plots in D represent the entire MVB sample from 79 cells of TG.

Once obtained, the coordinate values of the CG and TG were compared using the density-based method of the present invention. The results for the comparison TG/CG give a P_{2D}-value=0.015, well below a typical significance level of 0.05, which is a strong and reliable indication that both samples Im1 and Im2 are different. Thus, we conclude that Kif5B plays a role in MVB morphology.

As a negative control, we compared the coordinate samples between the duplicate experiments. The results for the comparison between duplicates give P_{2D}-values well above typical significance levels of 0.05. This is a very strong and reliable indication that duplicates are similar.

The above-mentioned method for determining the influence of modified expression levels of different cellular components on intracellular compartments, can be used for determining the function of proteins. In the case, in which P-values are below typical significance levels, it can be concluded that a cellular component plays a role in the steady-state distribution of the structures analyzed. In the case, in which P-values are above typical significance levels, it can be concluded that a cellular component has no role in the steady-state distribution of the structures analyzed.

### Example No. 5

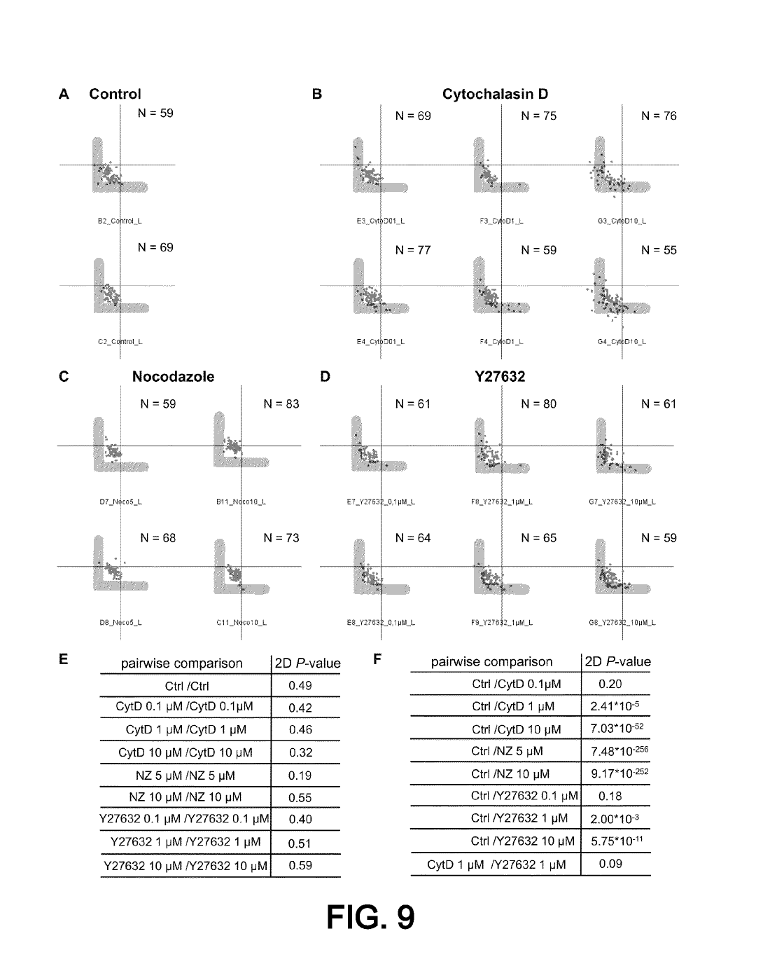

FIG. 9 illustrates a further example No. 5, wherein the influence of different compounds at varying concentrations on biological structures is determined using the above-described method.

In these examples, the positioning of the cellular nucleus was compared in the presence, absence and at varying concentrations of different drugs in HeLa cells.

### Material and Methods

Human HeLa cells kept in growth medium were trypsinized and seeded on micropattern-printed coverslips as described in EP 1664266. The drugs Nocodazole, Cytochalesin D and Y27632 were applied at varying concentrations (0.1 μM, 1 μM, 10 μM) and cells were incubated for 1 h at 37° C. Cells were fixed with 4% (wt/vol) paraformaldehyde (PFA) and the nucleus was visualized by 0.0002 mg/ml DAPI. Samples were prepared as duplicates. Images of <50 cells of each condition were acquired with 40× magnification. Images were segmented in order to define the center of each nucleus. The coordinates of all nuclei from the same condition were aligned using the micropattern geometry and pooled. The coordinate samples of all TG were compared with the coordinate sample of the CG using the above-described method. The coordinate samples between the duplicates were compared, representing control conditions.

### Results

Part A of FIG. 9 illustrate the scatter plots of the aligned coordinates of nuclei obtained after the segmentation analysis on L-shaped patterns at different conditions. Each coordinate stands for one nucleus. The coordinate values of the CG and TG were compared using the density-based method of the present invention.

The results for the comparison TG/CG give P_{2D}-values well below a typical significance level of 0.01 and 0.05 for the higher doses of the drugs, whereas lower doses of the drugs give less significant P-values. This example demonstrates that the P-value allows quantification of the drug effect. Furthermore, this analysis allows to compare effects of different drugs.

As a negative control, we compared the coordinate samples between the duplicate experiments. The results for the comparison between duplicates give P_{2D}-values well above typical significance levels of 0.01 or 0.05. This is a very strong and reliable indication that duplicates are similar.

This example of the above-mentioned method, demonstrates that different chemical compounds can be analyzed. Furthermore, it demonstrates that a concentration-dependent effect of compounds can be quantified by the calculated P-values. The smaller the P-values are, the stronger is the effect of a compound analyzed. Moreover, the above-mentioned method allows to compare the effects of different compounds and to detect similar effects of different compounds.

### Example No. 6

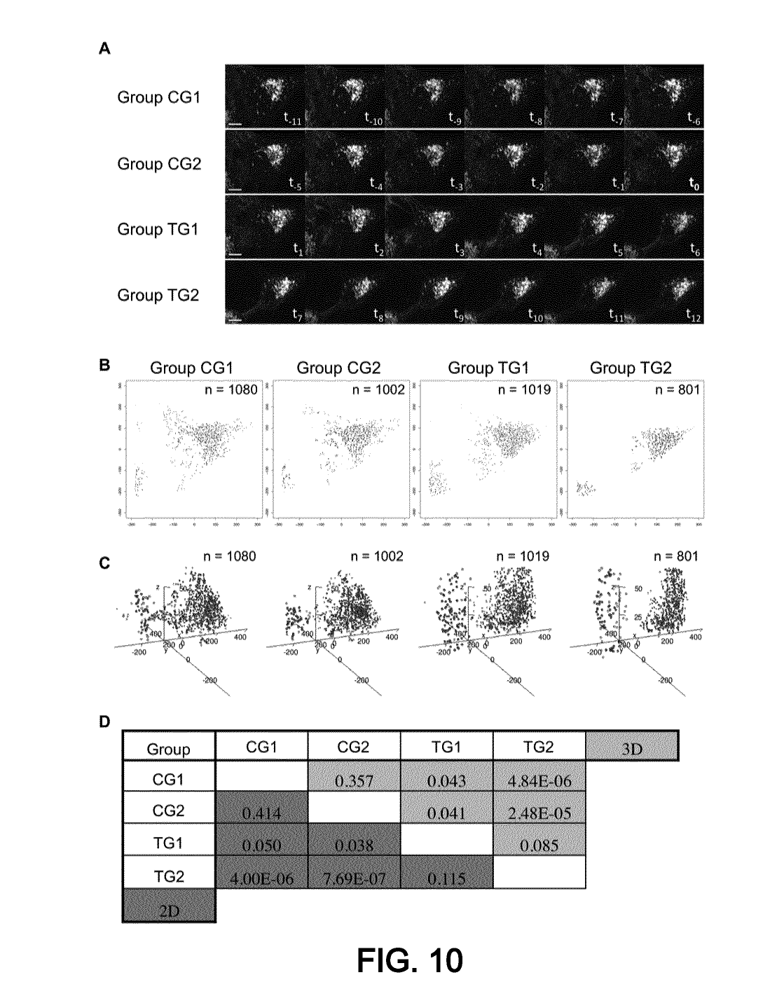

FIG. 10 illustrates a further example No. 6, wherein the influence of a compound on biological structures in classical cell culture condition, in which cells were plated on uncoated coverslips, is determined using the above-described method.

In this example, morphological changes in the steady-state organization of MVB were monitored in a time period between two instants t1 and t2 when using a drug treatment. Thus, the density-based method of the present invention is applied to life cell analysis. More precisely, MVB were analyzed in unconstrained cells before and after treatment with nocodazole, illustrating that the present invention is not limited to the comparison of constrained cells but can also apply to the comparative study of unconstrained cells.

### Material and Methods

EGFP-CD63-expressing stable cells (generated by transfection of the plasmid pEGFP-CD63, Ostrowski et al. NATURE CELL BIOLOGY, January 2010) into RPE-1 cells and selection with 500 μg/ml geneticin) were seeded on iwaki glass base dishes (Asahi Glass) for live cell observation. To depolymerize microtubules, nocodazole (NZ) was added to a final concentration of 20 μM. Live cell imaging was performed on a Yokogawa spinning disc inverted microscope using 60× magnification and Z-series every 0.2 μm. Three-dimensional stacks of cells were acquired during 24 minutes, with an acquisition frequency of one acquisition each 60 seconds, therefore leading to the acquisition of a movie containing 24 images. Images were segmented in order to detect signals over noise. The coordinates of the segmented structures from six time points were pooled. The first two groups contained images in the absence of the drug (CG1 and CG2) and the second two groups contained images in the presence of the drug (TG1 and TG2) recorded after the addition of the drug. The coordinate samples of each group were compared using the above-described method.

### Results

FIG. 10 illustrate 24 fluorescent images of the movie that have been analyzed. Intracellular MVB were visualized by a green fluorescent protein (GFP)-tagged CD63 enriched on MVB.

The images are chronologically split into four groups (1-4) containing each six images, as shown in part A of FIG. 10:

Groups CG1 and CG2 are non-treated control groups with 1080 and 1002 detected CD63-positive structures that were acquired before addition of the drug.

Groups TG1 and TG2 are treated test groups containing 1019 and 801 structures that were recorded after the addition of the drug.

Parts B and C of FIG. 10 illustrate two-dimensional (B) and three-dimensional (C) scatter plots of the coordinates of each pooled group obtained after the segmentation analysis. Each coordinate stands for one segmented CD63-marked structure, whereas the scatter plots represent the entire MVB sample from six time frames.

The density-based test statistic of the present invention was then applied on each of the possible combination of pairs of these groups, in order to study the morphological evolution of the cells when a drug is administrated.

The corresponding p-values obtained for the two-dimensional and three-dimensional comparison are listed in the table shown in part D of FIG. 10.

The results of the comparison indicate clearly that, whereas no significant changes in CD63 morphology was detected before the drug treatment (P_{2D}-value of 0.414 and P_{3D}-value of 0.357) when comparing non-treated groups CG1 and CG2, the treatment with nocodazole significantly affects the CD63-morphology (P_{2D}-value of 4.00*10⁻⁶ and P_{3D}-value of 4.84*10⁻⁶ when comparing non-treated group CG1 with the last one of treated group TG2.

It is to be noted that the effect of the drug was only significant for later time points in agreement with visual inspection of the images and known time intervals for nocodazole treatment. Thus, the density-based approach of the present invention allows also unbiased automated detection of morphological changes in live-cell assays in unconstrained cells.

### Examples No. 7 and No. 8

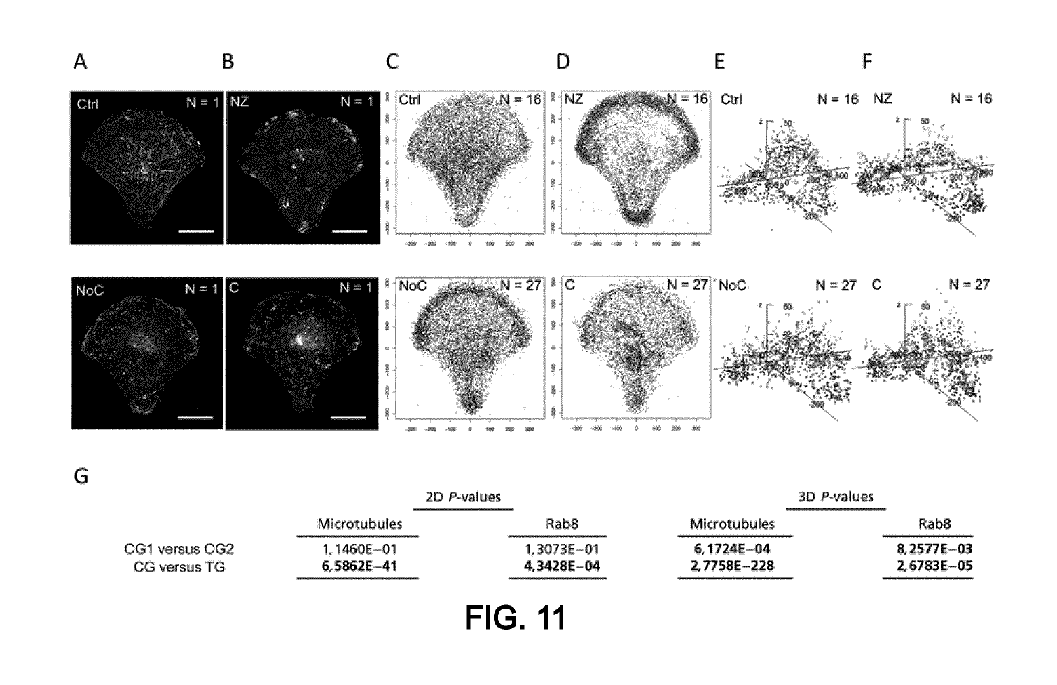

FIG. 11 illustrates two different examples No. 7 and No. 8 of continuous cellular structures whose morphology changes can be quantified with the above-described method.

As examples of continuous cellular structures, microtubules that are part of the cellular cytoskeleton and the primary cilium that is a filamentous extension of the cell have been analyzed. Such analysis aims at investigating whether it is possible or not to distinguish between the presence and absence of microtubules and the presence and absence of a primary cilium in a given cell population using the above-described method.

In example No. 7 illustrated on FIG. 11 (upper panel), a sample that has been stained for microtubules marked by β-tubulin, in the presence and absence of the drug nocodazole that depolymerizes microtubules has been analyzed.

The staining of β-tubulin from the CG (represented by Im1) and the TG after addition of the drug nocodazole (represented by Im2) are compared.

In example No. 8 illustrated on FIG. 11 (lower panel), Rab8-marked membrane domains that are visualized by a stably over-expressed green fluorescent protein (GFP)-Rab8 fusion are analyzed. Rab8 is a small GTPase that regulates trafficking and that accumulates in the primary cilium.

The analysis aims at determining whether the cells that do not contain a primary cilium, the CG (represented by Im1) can be distinguished from cells that contain a primary cilium, the TG (represented by Im2).

### Material and Methods

Human RPE-1 cells kept in growth medium were trypsinized and seeded on micropattern-printed coverslips as described in EP 1664266. To depolymerize microtubules, nocodazole was added to a final concentration of 10 M to TG. TG and CG were both subsequently incubated for 1 h at 4° C. and 1 h at 37° C. Cells were fixed with 4% (wt/vol) paraformaldehyde (PFA) and proceeded for indirect immunofluorescence staining with primary β-tubulin antibodies (Sigma-Aldrich) to visualize microtubules and fluorophore-coupled secondary antibodies.

Human RPE-1 cells stably expressing GFP-Rab8 and kept in growth medium were trypsinized and seeded on micropattern-printed coverslips as described in EP 1664266. Cells were sorted based on the fact whether they contained a primary cilium or not.

3D image stacks of n cells of each condition (TG and CG) were acquired with 100× magnification and Z-series every 0.2 m. Images were deconvolved and segmented in order to detect signals that are larger than noise. To represent continuous structures (microtubules and Rab8-marked membranes domains) by a cloud of coordinates, we “cut” them in several small structures by increasing the watershed during segmentation. The coordinates of the segmented structures from all cells were aligned using the micropattern geometry and the coordinate sample of the TG was compared with the coordinate sample of the CG using the above-described method for each intracellular compartment analyzed.

### Results

### Example No. 7

Parts A and B of FIG. 11 illustrate representative fluorescent images of one cell from CG (designated by “Crtl”) and one cell from TG (designated by “NZ” for nocodazole) stained for tubulin and visualized by indirect immunofluorescence in the presence and absence of nocodazole. Scale bars are 10 μm.

Parts C,D and E,F of FIG. 11 illustrate two-dimensional (C,D) and three-dimensional (E,F) scatter plots of the aligned coordinates obtained after the segmentation analysis. Each coordinate stands for one fluorescent fragment. The scatter plots in C,E represent tubulin structures from 16 cells of CG, while the scatter plots in D,F represent tubulin structures from 16 cells of TG.

Once obtained, the coordinate values of the CG and TG were compared using the density-based method of the present invention. The results for the comparison TG/CG give p-values of P_{2D}-value=6.5862*10⁻⁴¹ and P_{3D}-value=2.7758*10⁻²²⁸, well below a typical significance level of 0.05 or 0.01, which is a very strong and reliable indication that both samples Im1 and Im2 are different. Thus, we conclude that our test statistic could distinguish between the presence or absence of microtubules due to treatment with nocodazole.

Additionally, we performed a negative control experiment, in which we compared tubulin structures from the same CG (here called CG1) with tubulin structures from a second disjoint control group (CG2) of 16 cells.

The coordinate values of tubulin of the CG1 and CG2 were compared using the density-based method of the present invention. The results for the comparison CG1/CG2 give a P_{2D}-value of 0.1146, well above typical significance levels of 0.1 or 0.05. This is a very strong and reliable indication that both subsamples are similar in 2D, and thus that the differences between these control groups are not biologically significant i.e. there are no morphological differences. Whereas the P_{2D}-value for control half samples was not significant, the corresponding P_{3D}-value was 6.1724*10⁻⁴, thus below typical significance levels of 0.1 or 0.05. Because coordinates from continuous structures were not independent, our test statistic became suboptimal. Indeed, the formula for the estimated variance is divided by the number of independent structures; thus, the variance is overestimated for dependent structures, leading to smaller P-values. Nonetheless, even though the computed P_{3D}-value for microtubules was smaller than its true value, we could still clearly distinguish between the presence and absence of microtubules. The P-values between control half samples CG1 and CG2 were orders of magnitude bigger than those for the comparison of different conditions CG and TG.

### Example No. 8

Parts A and B of FIG. 11 illustrate representative fluorescent images of one cell from CG (designated by “NoC” for no primary cilium) and one cell from TG (designated by “C” for presence of a primary cilium). The primary cilium was visualized by GFP-Rab8 that accumulates in the cilium when present. Scale bars are 10 μm.

Parts C,D and E,F of FIG. 11 illustrate two-dimensional (C,D) and three-dimensional (E,F) scatter plots of the aligned coordinates obtained after the segmentation analysis. Each coordinate stands for one fluorescent fragment. The scatter plots in C,E represent Rab8-marked structures from 27 cells of CG, while the scatter plots in D,F represent Rab8-marked structures from 27 cells of TG.

Once obtained, the coordinate values of the CG and TG were compared using the density-based method of the present invention. The results for the comparison TG/CG give a P_{2D}-value=4.3428*10⁻⁴ and P_{3D}-value=2.6783*10⁻⁵, well below a typical significance level 0.05 or 0.01, which is a very strong indication that both samples Im1 and Im2 are different. Thus, we conclude that our test statistic could distinguish between the presence or absence of a primary cilium in a given cell population.

Additionally, we performed a negative control experiment, in which we compared Rab8-marked structures from the same CG (here called CG1) with Rab8-marked structures from a second disjoint control group (CG2) of 27 cells.

The coordinate values of the CG1 and CG2 were compared using the density-based method of the present invention. The results for the comparison CG1/CG2 give a P_{2D}-value of 0.1307, well above typical significance levels of 0.1 or 0.05. This is a very strong and reliable indication that both subsamples are similar in 2D, and thus that the differences between these control groups are not biologically significant i.e. there are no morphological differences. Whereas the P_{2D}-value for control half samples were not significant, the corresponding P_{3D}-value was 8.2577*10⁻³, thus below typical significance levels of 0.1 or 0.05. Because coordinates from continuous structures were not independent, our test statistic became suboptimal. Indeed, the formula for the estimated variance is divided by the number of independent structures; thus, the variance is overestimated for dependent structures, leading to smaller P-values. Nonetheless, even though the computed P_{3D}-value for Rab8-marked structures was smaller than its true value, we could still clearly distinguish between the absence and presence of a primary cilium. The P-values between control half samples CG1 and CG2 were orders of magnitude bigger than those for the comparison of different conditions CG and TG.

### Example No. 9

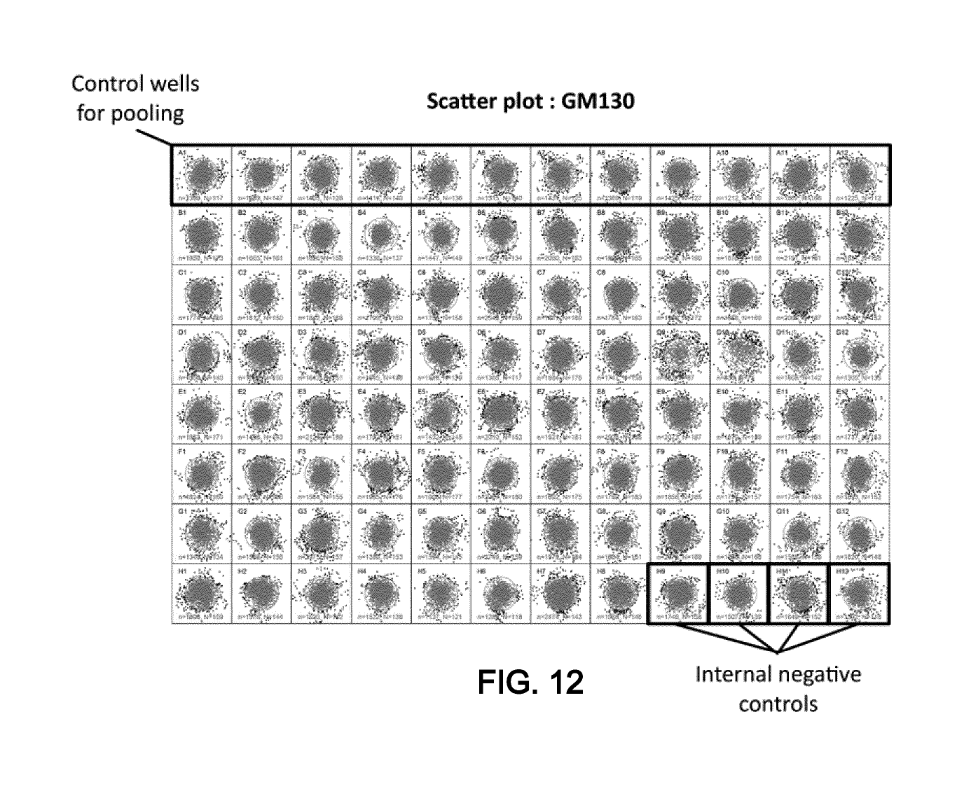

FIG. 12-15 illustrate another example No. 9, wherein the above-described method is used in a drug library screen to identify inhibitors that alter the morphology of intracellular structures.

In this example screen, one determines the influence of a library of compounds on different biological structures using the above-described method. We asked which kinase, phosphatase and protease inhibitor altered the morphologies of lysosomes (marked by Lamp1) and the Golgi apparatus (marked by GM130). We used The Screen-Well™ Inhibitor Library containing 80 known kinase inhibitors of well-defined activity, 53 known protease inhibitors of well-defined activity and 33 known phosphatase inhibitors of well-defined activity. We screened using the 96-well format. Each 96-well plate contained several control wells, in which dimethyl sulfoxid (DMSO) was added. These wells were pooled and represented the CG of the plate. In the remaining wells, different inhibitors (dissolved in DMSO) were added in the way that each well contained one specific inhibitor representing a TG. Some of the wells lacked the inhibitor and represented thus internal negative controls (CGi). Some of the wells contained nocodazole that changes the morphology of lysosomes and the Golgi apparatus and represented thus internal positive controls.

### Material and Methods

On three independent days, human PRE-1 cells kept in growth medium were trypsinized and seeded in 96-well plates containing micropatterns as described in EP 1664266. After cells spread on micropatterns for 3 h, different controls or inhibitors were added at 10 μM concentration in each well. Cells were incubated for one hour and the entire plate was fixed with 4% (wt/vol) paraformaldehyde (PFA) and proceeded for indirect immunofluorescence staining with primary α-Lamp1 antibodies to visualize lysosomes and α-GM130 antibodies to visualize the Golgi apparatus as well as fluorophore-coupled secondary antibodies. Images were acquired at 20×. We analyzed data from 42 fields/well using ImageJ (with an in-house cell sorting and centering program) identifying about 150 patterned single cells/well. Images of single cells were segmented by detecting signals that were five-fold larger than noise in order to measure the coordinates of lysosomes and Golgi stacks. The coordinates of the segmented structures (either lysosomes or Golgi apparatus) from all cells in one well were aligned using the micropattern geometry. The aligned coordinates from each well containing treatment condition (TG) were compared to a pooled control (CG) containing the cells of several control (DMSO) wells. The coordinate sample of the TG was compared with the coordinate sample of the CG using the above-described method for each intracellular compartment analyzed. ‘Hits’ were selected based on the P-value calculated from the difference between the coordinate sample of the CG and the coordinate sample of each treatment condition. For instance, ‘Hits’ were selected if the P-value of the difference in intracellular organization was smaller than 0.001.

### Results

FIG. 12 illustrates the two-dimensional scatter plots of one 96-well plate of the kinase inhibitor screen of the first experiment. The aligned coordinates of GM130-marked structures from all cells in each well are projected into the corresponding 96-well field. Each 96-well plate contained 12 control wells, in which dimethyl sulfoxid (DMSO) was added. These wells were pooled and represented the CG of the plate. All the remaining wells represent the independent TG. The coordinate values of each well (each TG) were compared with the pooled CG using the density-based method of the present invention. Some of the wells lacked the inhibitor and represented thus internal negative controls (CGi).

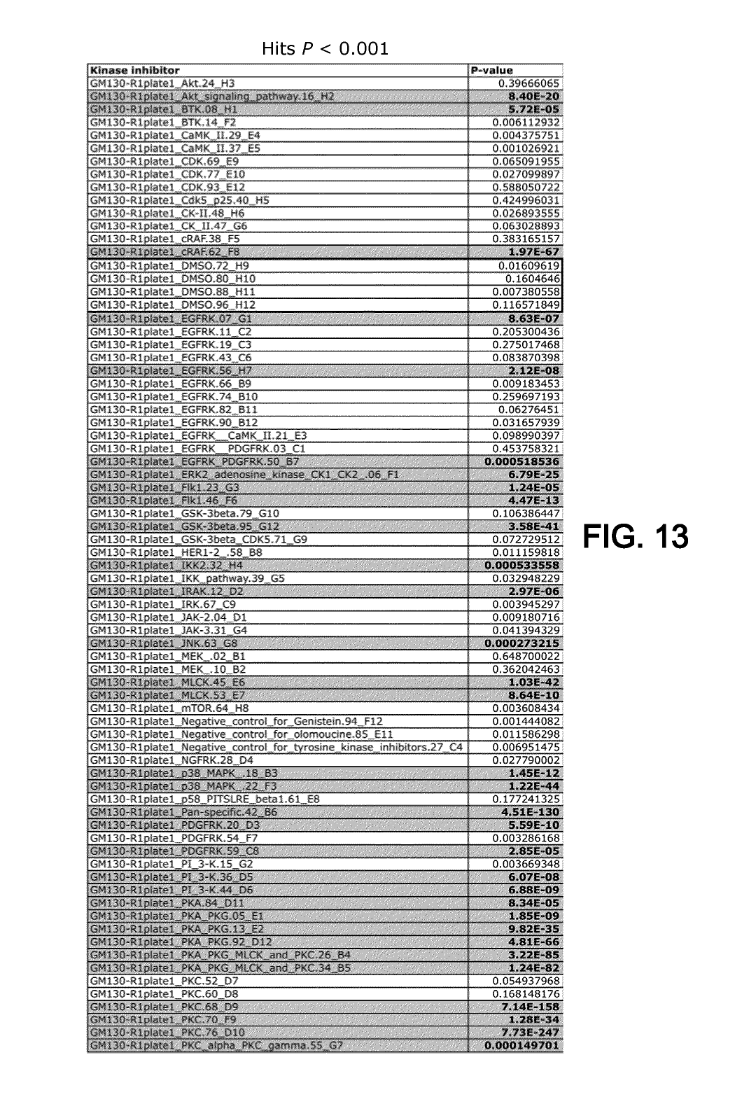

FIG. 13 shows an extract of the table of calculated P-values for each comparison between CG/TG and CG/CGi of one 96-well plate of the kinase inhibitor screen of the first experiment. The significance level was set by taking into account the internal positive controls and negative controls. For example, P-values that were below 0.001 were considered to be significant for the shown plate. “Hits” were selected if two out of three replicates were below the significance level. Globally, we found 27% ( 45/166) of all studied inhibitors gave hits. We found 45% ( 36/80) of kinase inhibitors, 9% ( 3/33) of phosphatase inhibitors and 11% ( 6/53) of protease inhibitors disturbed the morphology of either the Golgi apparatus of lysosomes. We found that the positioning of lysosomes was specifically regulated by 38% ( 17/45) of the identified hits. The morphology of the Golgi apparatus was specifically regulated by 15% ( 7/45) of the identified hits. Surprisingly, the majority of identified hits 47% ( 21/45) disturbed both, the lysosomal compartment and the Golgi apparatus. We found one internal hit in our negative control ( 1/62) that gave a false positive result. We used treatment with nocodazole as an internal positive control and found all wells containing nocodazole as hits, leading to 0% ( 0/24) false negative.

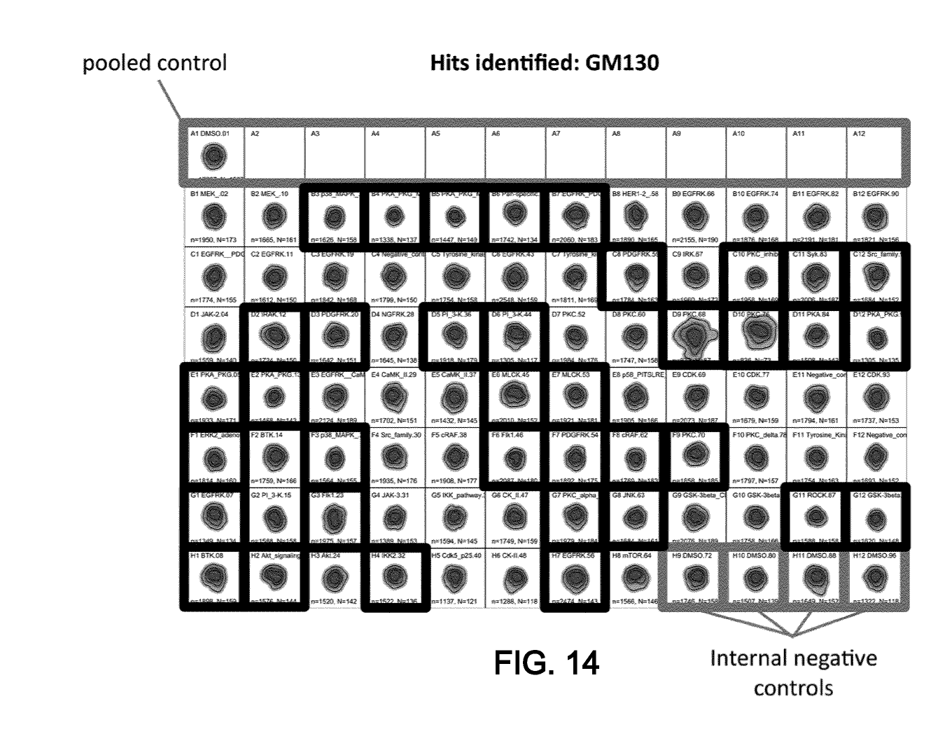

FIG. 14 illustrates the corresponding density maps of one 96-well plate of the kinase inhibitor screen of the first experiment. Density maps represent the smallest region where a given percentage of the most concentrated structures are found, e.g. the light gray contour represent the 75%, the gray contour 50% and the dark gray contour 25% of structures. Density maps were used to measure and visualize the organization of marked structures as in Schauer et al. 2010. The 12 DMSO control wells were pooled and represent the reference map of the CG (framed in gray rectangle). The maps of all the remaining wells represent independent TG of which several were internal negative controls (CGi). Hits that were identified on this plate map (P<0.001) with the above-described method (see FIG. 13) are framed in black squares, internal negative controls (CGi) are framed in gray squares.

### Example No. 10

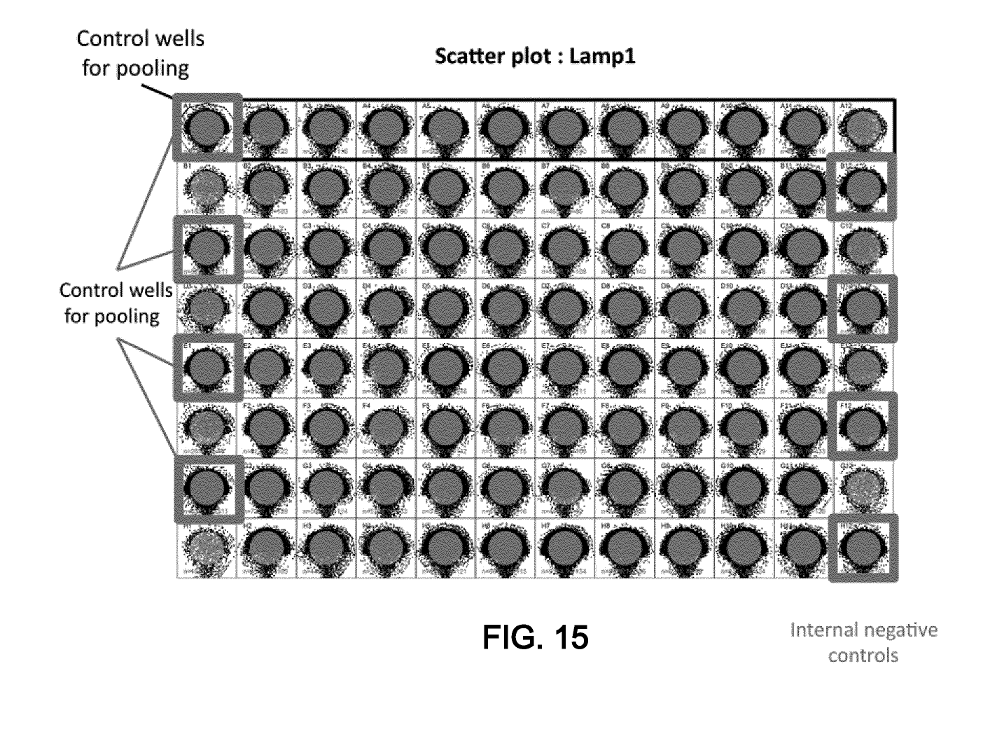

FIG. 15 illustrates another example No. 10, wherein the above-described method is used in a siRNA-based screen for loss of function analysis.

In this example screen, we used a siRNA-library against cellular motor proteins to identify which motors influence the morphology of different biological structures using the above-described method. We asked which kinesins define the morphologies of lysosomes (marked by Lamp1) and the Golgi apparatus (marked by GM130). We screened using the 96-well format. Each 96-well plate contained several control wells, in which cells were transfected with siRNA against luciferase. These wells were pooled and represented the CG of the plate. In the remaining wells, siRNA against different kinesins were transfected in the way that each well contained one specific siRNA. Some of the wells contained siRNA against luciferase and represented thus internal negative controls (CGi). Some of the wells lacked any siRNA and represented alternative negative controls (CGa).

### Material and Methods

Human RPE-1 cells were transfected with siRNAs targeting a control gene (luciferase, representing CG) and the kinesin siRNA library (representing TG) using standard protocols. Each kinesin motor was targeted by four independent siRNAs. After three days of knock down, cells were trypsinized and seeded in 96-well plates containing micropatterns as described in EP 1664266. After cells spread on micropatterns for 3 h, cells were fixed with 4% (wt/vol) paraformaldehyde (PFA) and proceeded for indirect immunofluorescence staining with primary α-Lamp1 antibodies to visualize lysosomes and α-GM130 antibodies to visualize the Golgi apparatus as well as fluorophore-coupled secondary antibodies. 2D images were acquired at 20×. We analyzed data from 42 fields/well using an in-house cell sorting and centering program running under ImageJ identifying about 150 patterned single cells/well. Images of single cells were segmented by detecting signals that were five-fold larger than noise in order to measure the coordinates of lysosomes and Golgi stacks. The coordinates of the segmented structures (either lysosomes or Golgi apparatus) from all cells in one well were aligned using the micropattern geometry. The aligned coordinates from each well containing one specific siRNA (TG) were compared to a pooled control (CG) containing the cells of several control (siRNA against luciferase) wells. The coordinate sample of the TG was compared with the coordinate sample of the CG using the above-described method for each intracellular compartment analyzed. The analysis of these hits is in progress. ‘Hits’ were selected based on the P-value calculated from the difference between the density map of a pooled control (DMSO treatment) and the density map of each treatment condition. ‘Hits’ were selected if the P-value of the difference in intracellular organization was smaller than a significance level.

### Results

FIG. 15 illustrates the two-dimensional scatter plots of one 96-well plate of the kinesin motor screen of the first experiment. The aligned coordinates of Lamp1-marked structures from all cells in each well are projected into the corresponding 96-well field. Each 96-well plate contained four control wells, in which in which cells were transfected with siRNA against luciferase. All the remaining wells represent the independent TG. The coordinate values of each well (each TG) were compared with the pooled CG using the density-based method of the present invention. Some of the wells contained siRNA against luciferase and represented thus internal negative controls (CGi). Some of the wells lacked siRNA and represented thus alternative negative controls (CGa).

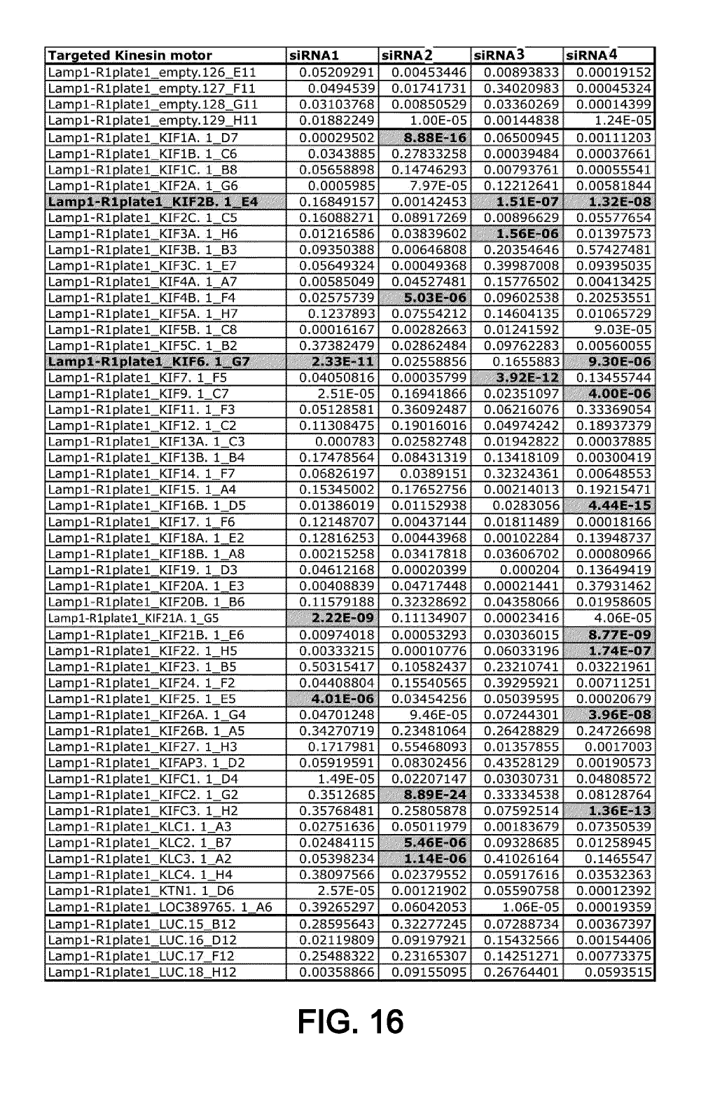

FIG. 16 shows an extract of the table of calculated P-values for each comparison between CG/TG and CG/CGi of one 96-well plate of the kinase inhibitor screen of the first experiment. The significance level was set by taking into account all negative controls. “Hits” were selected if two out of four independent siRNAs used were below the significance level. We found two kinesins that specifically defined the morphology of lysosomes (Kif2B and Kif6) and five kinesins that specifically defined the morphology of the Golgi apparatus (Kif3C, Kif4B, Kif17, Kif21B and Kif26A). We did not find any false positive hits in our negative controls.

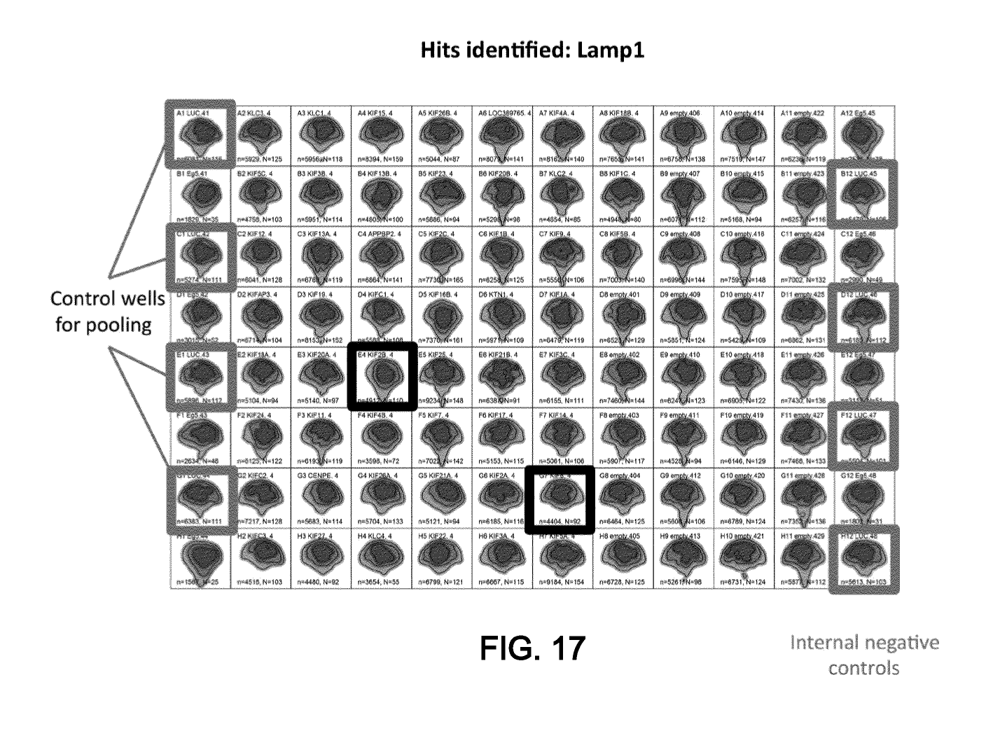

FIG. 17 illustrates the corresponding density maps of one 96-well plate of siRNA4. Density maps represent the smallest region where a given percentage of the most concentrated structures are found, e.g. light gray contour represent the 75%, the gray contour 50% and the dark gray contour 25% of structures. Density maps were used to measure and visualize the organization of marked structures as in Schauer et al. 2010. Four luciferase control wells were pooled and represent the reference map of the CG (framed in gray rectangle). The maps of all the remaining wells represent independent TG. Hits that were identified with the above-described method are framed in black squares, internal negative controls (CGi) are framed in gray squares.

These two last examples demonstrate that the above-mentioned method for determining changes in cellular morphology can be applied in high-throughput screenings. It can be used to identify compounds that modify different cellular components, or can be used for determining the function of proteins when used in combination with siRNA. In the case, in which P-values are below a defined significance level, it can be concluded that a cellular component plays a role in the steady-state distribution of the structures analyzed. In the case, in which P-values are above a defined significance level, it can be concluded that a cellular component has no role in the steady-state distribution of the structures analyzed.

Throughout this application, various references describe the state of the art to which this invention pertains. The disclosures of these references are hereby incorporated by reference into the present disclosure.

While the invention has been illustrated and described in detail in the drawings and detailed description, such illustration and description are to be considered illustrative or exemplary and not restrictive, the invention being not restricted to the disclosed embodiments. Other variations to the disclosed embodiments can be understood and effected by those skilled in the art in practicing the claimed invention, from a study of the drawings, the disclosure and the appended claims.

In particular, though various examples relating to the biological field have been mentioned to illustrate potential applications of the present method of comparing images, such a method is not limited to such a field of application and can find applications in other fields where the automatic detection of a structural change in an element or an object is required.

In the claims, the word “comprising” does not exclude other elements or steps, and the indefinite article “a” or “an” does not exclude a plurality. A single processor or other unit may fulfill the functions of several items recited in the claims. The mere fact that different features are recited in mutually different dependent claims does not indicate that a combination of these features cannot be advantageously used. Any reference signs in the claims should not be construed as limiting the scope of the invention.

1. Method of processing data for comparing at least two images using data processing means, said method comprising:
extracting (100) a first sample of coordinate values (X₁, X₂, . . . Xₙ₁) from at least one first image (Im1) and a second sample of coordinate values (Y₁, Y₂, . . . Yₙ₂) from at least one second image (Im2);
computing (200), with said processing means, an approximate normal score value (Z) based on a density test statistic function (\hat{T}) applied on the first and second samples of coordinate values, wherein said density test statistic function has an asymptotic distribution;
comparing (400) a p-value, derived from the computed normal score value (Z), with a predetermined level of significance (α) in order to determine a similarity between the two images.

2. Method of processing data according to claim 1, wherein it is determined that the two images are different, if the p-value is less or equal to the predetermined level of significance (α), whereas it is determined that the two images are similar if the p-value is higher than this predetermined level of significance (α).

3. Method of processing data according to claim 1, wherein the normal score value (Z) depends on the mean value (\hat{μ}_{T}) of the density test statistic function (\hat{T}), said method comprising further:
selecting (210) a first and a second optimal bandwidth matrices (H₁,H₂) which are associated respectively with the first and second samples of coordinate values, wherein said bandwidth matrices are preferably a sequence of symmetric positive definite matrices; and
determining (220) the mean value estimator (\hat{μ}_{T}) of the density test statistic function (\hat{T}) based on the selected optimal bandwidth matrices;
wherein the density test statistic function (\hat{T}) is preferably based on a first estimator (\hat{ψ}₁) of a first integrated density functional (ψ₁) associated with the first sample of coordinate values and a second estimator (\hat{ψ}₂) of a second integrated density functional (ψ₂) associated with the second sample coordinate values; and
wherein said first and second bandwidth matrices are preferably selected (210) to minimize the mean square error respectively of the first and second estimators in the space of all symmetric positive definite matrices.

4. Method of processing data according to claim 1, wherein the normal score value (Z) depends on an estimate (\hat{σ}_{T}²) of the variance of the density test statistic function, said method further comprising the determination (230) of the variance based on a first and second variance estimators (\hat{σ}₁², \hat{σ}₂²) of density estimates associated respectively with the first and second samples of coordinate values.

5. Method of processing data according to claim 1, wherein the approximate normal score value (Z) is computed (240) according to the following equation:
$$Z = \frac{\hat{T} - {\hat{μ}}_{T}}{\sqrt{{\hat{σ}}_{T}^{2} \cdot ( \frac{1}{{n}_{1}} + \frac{1}{{n}_{2}} )}}$$
wherein:
Z is the normal score value;
\hat{T} is a density test statistic function having an asymptotic distribution;
\hat{μ}_{T} is the mean value estimator of the density test statistic function \hat{T};
\hat{σ}_{T}² is the variance estimator of the density test statistic function \hat{T}; and
n₁ and n₂ are the number of coordinate values of the first and second samples, respectively.

6. Computer program product comprising code instructions for implementing the steps of a method of processing data according to claim 1, when loaded and run on data processing means of an analyzing device.

7. Method for detecting a change between a first biological structure (A) and a second biological structure (B), said method comprising the step of comparing (520) an image (ImA) of the first biological structure (A) to an image (ImB) of the second biological structure (B) using the method according to claim 1,
wherein a change is detected when the image (ImA) of the first biological structure (A) and the image (ImB) of the second biological structure (B) are not found similar by said method.

8. The method according to claim 7, wherein the first biological structure (A) has not been subjected to a compound (D) and the second biological structure (B) has been subjected to a compound (D),
and wherein the detection of change between the first biological structure (A) and the second biological structure (B) is indicative of an effect, preferably of a therapeutic and/or cytotoxic effect, of said compound (D) on the biological structure.

9. The method according to claim 7, wherein the first biological structure (A) has been subjected to a first amount of a compound (D) and the second biological structure (B) has been subjected to a second amount of a compound (D), different from the first amount,
and wherein the detection of change between the first biological structure (A) and the second biological structure (B) is indicative of an effect, preferably of a therapeutic and/or cytotoxic effect, of the amount of said compound (D) on the biological structure.

10. The method according to claim 8, for use in methods for screening compounds, preferably siRNA compounds.

11. The method according to claim 7, wherein the first biological structure (A) has been obtained from a patient suffering from a disease before the beginning of a treatment of the disease or in course of said treatment, and the second biological structure (B) has been obtained from the same patient subsequently in course of said treatment, and wherein the absence of detection of a change between the first biological structure (A) and the second biological structure (B) is indicative of resistance of the patient to said treatment.

12. The method according to claim 7, wherein the first biological structure (A) has been obtained from a patient suffering from a disease, and the second biological structure (B) has been obtained from a patient to be diagnosed,
and wherein the absence of detection of a change between the first biological structure (A) and the second biological structure (B) is indicative that the patient to be diagnosed suffers from said disease.

13. The method according to claim 7, wherein the biological structure is a group of cells, an isolated cell, or a cell component such as a chloroplast, endoplasmic reticulum, in particular the endoplasmic reticulum exit sites (ERES), Golgi apparatus, mitochondria, vacuole, nucleus, ribosome, membrane domain, cytoskeleton including microfilaments, microtubules, and intermediate filaments, flagellum, cilium, centriole, or an intracellular multivesicular body.

14. The method according to claim 7, wherein the change is a morphological change or a molecular change, said morphological change being selected from the group comprising a change in the inner architecture of the biological structure and a change in the overall morphology of the biological structure; and said molecular change being selected from the group comprising a change in the molecular signaling inside the biological structure.

15. The method according to claim 7, wherein the biological structure is a constrained cell or a group of constrained cells, said constrained cell or group of constrained cells being preferably constrained using a micro-pattern, more preferably an anisotropic adhesion pattern to which only one cell can adhere and which is either concave or have a long and thin adhesive area with a shape factor of less than 0.6.

16. The method according to claim 7, wherein the biological structure is an infected cell, a group of infected cells, a cancer cell or a group of cancer cells.

17. An analyzing device for detecting a change in a biological structure, the analyzing device comprising:
image acquiring means able to capture at least one first image (Im1) of a first element of said biological structure and at least one second image (Im2) of a second element of said biological structure;
processing means configured to extract a first sample of coordinate values (X₁, . . . , Xₙ₁) from said first image (Im1) and a second sample of coordinate values from said second image (Im2), compute a normal score value (Z) based on a density test statistic function (\hat{T}) applied on the first and second samples of coordinate values, wherein said density test statistic function has an asymptotic distribution, and compare a p-value, derived from the computed normal score value (Z), with a predetermined level of significance (α) in order to determine a similarity between the first and second images.

18. Method of processing data according to claim 2, wherein the normal score value (Z) depends on the mean value (\hat{μ}_{T}) of the density test statistic function (\hat{T}), said method comprising further:
selecting (210) a first and a second optimal bandwidth matrices (H₁,H₂) which are associated respectively with the first and second samples of coordinate values, wherein said bandwidth matrices are preferably a sequence of symmetric positive definite matrices; and
determining (220) the mean value estimator (\hat{μ}_{T}) of the density test statistic function (\hat{T}) based on the selected optimal bandwidth matrices;
wherein the density test statistic function (\hat{T}) is preferably based on a first estimator (\hat{ψ}₁) of a first integrated density functional (ψ₁) associated with the first sample of coordinate values and a second estimator (\hat{ψ}₂) of a second integrated density functional (ψ₂) associated with the second sample coordinate values; and
wherein said first and second bandwidth matrices are preferably selected (210) to minimize the mean square error respectively of the first and second estimators in the space of all symmetric positive definite matrices.

19. Method of processing data according to claim 2, wherein the normal score value (Z) depends on an estimate (\hat{σ}_{T}²) of the variance of the density test statistic function, said method further comprising the determination (230) of the variance based on a first and second variance estimators (\hat{σ}_{T}², \hat{σ}₂²) of density estimates associated respectively with the first and second samples of coordinate values.

20. Method of processing data according to claim 2, wherein the approximate normal score value (Z) is computed (240) according to the following equation:
$$Z = \frac{\hat{T} - {\hat{μ}}_{T}}{\sqrt{{\hat{σ}}_{T}^{2} \cdot ( \frac{1}{{n}_{1}} + \frac{1}{{n}_{2}} )}}$$
wherein:
Z is the normal score value;
\hat{T} is a density test statistic function having an asymptotic distribution;
\hat{μ}_{T} is the mean value estimator of the density test statistic function \hat{T};
\hat{σ}_{T}² is the variance estimator of the density test statistic function \hat{T}; and
n₁ and n₂ are the number of coordinate values of the first and second samples, respectively.
